(19) United States
(12) Patent Application Publication
(10) Pub. No.: US 2008/0236902 A1
(43) Pub. Date: Oct. 2, 2008

(54) Handwriting input system

(75) Inventor: Hideaki Imaizumi, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/078,124

(22) Filed: Mar. 27, 2008

(30) Foreign Application Priority Data
Mar. 28, 2007 (JP) 2007-084099

(51) Int. Cl. G06F 3/041

(52) U.S. Cl. 178/18.01

(57) ABSTRACT

A handwriting input system includes a handwriting input device, a mobile information device, and a server. The mobile information device includes a position determining unit with which, on request from the handwriting input device, the mobile information device determines its own position. The mobile information device assigns a position identifier to the position data, internally stores the position data and position identifier, and sends the position identifier to the handwriting input unit. The handwriting input unit attaches the position identifier to handwriting trace data that it captures and sends to the mobile information device. The mobile information device uses the position identifier to retrieve the position data and sends the position data with the handwriting trace data to the server. The server can thereby determine the geographical location at which handwriting was entered.

### BACKGROUND OF THE INVENTION

1. Field of the Invention

The present invention relates to a handwriting input system that converts handwritten input directly into electronic data and manages the data.

2. Description of the Related Art

Although the typical data input scenario has a person seated at a desk in an office, there is also need for data to be input by people traveling or working in the field, often outdoors. Known ways of entering and transmitting text data from outdoor locations include using the keyboard or touch panel of a mobile information device such as a portable computer or a personal digital assistant (PDA). When a touch panel is used, displayed letters or characters are selected with a stylus pen. The entered text may be sent to a destination address as electronic mail (e-mail), or as a file attached to an e-mail.

In another text input system known under the trade name Anoto, text is handwritten on special paper with a special digital pen referred to below as an electronic pen. By recognizing a unique pattern of fine dots (an Anoto code pattern) printed on the paper, electronic circuits in the pen identify the locations of the handwriting traces and generate trace data describing the traces. The trace data can be sent from the pen to a nearby mobile information device and then via a communication network to a central server, where the data can be stored and managed as text data. (One description of this system is given in Japanese Patent Application Publication No. 2004-341831).

A problem with using a keyboard or touch panel for field entry of data is that frequently the person entering the data is not accustomed to using a keyboard or touch panel and finds it less convenient than traditional handwriting.

The electronic pen system described above overcomes this problem but it only conveys the handwritten data from the field location to a central server; it fails to provide the data to the central server in a form that makes the data permanently useful. In particular, the server does not automatically receive information indicating where the data were entered. If, for example, the input data received by the server must be sorted by input location and processed for each location separately, which is often the case, then the user in the field must separately enter information indicating the input location. This is a time-consuming and mistake-prone task, and if the user forgets to enter the location or enters the location incorrectly, it can be extremely hard to determine the location later. If the location cannot be determined, the data may be useless.

Further problems arise when multiple electronic pens attempt to communicate with the same mobile information device.

### SUMMARY OF THE INVENTION

An object of the present invention is to provide a handwriting input system that converts handwritten input directly to electronic data and automatically adds information indicating the input location to the data.

Another object of the invention is to provide a handwriting input system in which a plurality of handwriting input devices can communicate with the same mobile information device.

The invention relates to a handwriting input system including a handwriting input device for capturing trace data describing handwriting traces, a mobile information device for receiving the trace data from the handwriting input device, and a server for receiving the trace data from the mobile information device, storing the trace data, and using the stored trace data in a prescribed application.

According to one aspect of the invention, the mobile information device includes a position determining unit, a first memory, a first processor, a first communication interface, and a server communication interface.

During operation, the first communication interface receives a position identifier request from the handwriting input device. The position determining unit obtains position data indicating the present position of the mobile information device. The first processor generates a position identifier, stores the position data and position identifier in the first memory, and sends the position identifier to the handwriting input device through the first communication interface.

In time, the first communication interface receives a first data set including trace data and the position identifier from the handwriting input device. The first processor uses the position identifier as a key to fetch the position data from the first memory, and generates a second data set including the trace data and position data. The server communication interface sends the second data set to the server.

The handwriting input device includes a second memory, a second processor, and a second communication interface. The second processor generates the position identifier request. The second communication interface sends the position identifier request and receives the position identifier. The second processor creates the first data set by storing the position identifier and the trace data captured by the handwriting input device in the second memory. The second communication interface sends the first data set to the mobile information device.

The server includes a third communication interface that receives the second data set from the mobile information device, and a third memory that stores the second data set.

As successive traces are captured by the handwriting input device and relayed by the mobile information device to the server, the position data included in each data set enables the server to determine where each trace was entered, without requiring the user to enter this information by hand.

According to a second aspect of the invention, the mobile information device includes a first memory, a first communication interface, and a server communication interface. The first communication interface receives data sets from the handwriting input devices. The first memory stores the received data sets. The server communication interface sends the received data sets to the server.

Each handwriting input device includes an identifier memory storing the input device identifier of the handwriting input device, a second memory for storing the trace data captured by the handwriting input device, and a second communication interface for sending data sets to the mobile information device. Each data set includes both trace data captured by the handwriting input device and the input device identifier stored in the identifier memory.

The server comprises a third communication interface for receiving the data sets from the mobile information device and a third memory for storing the data sets.

Since each handwriting input device puts its own identifier in the data set describing each captured handwriting trace, regardless of the order in which the data sets from different handwriting input devices are received by the mobile information device, the server can sort the data sets according to the input device identifiers they include and process the trace data received from each handwriting input device separately. People entering handwritten data at the same location can accordingly send data via the same mobile information device without having the server mistakenly processing traces entered by different handwriting input devices as input from the same person.

### BRIEF DESCRIPTION OF THE DRAWINGS

In the attached drawings:

FIG. 1 is a schematic block diagram showing the structure of a handwriting input system according to a first embodiment of the invention;

FIG. 2 is a flowchart illustrating the operation of the electronic pen in FIG. 1;

FIG. 3 is a table showing exemplary pen data numbers, pen time data, position identifiers, and trace data stored in the pen memory 205 of the electronic pen according to the first embodiment;

FIG. 4 is a flowchart illustrating conditions under which data stored in the electronic pen in FIG. 1 are sent to the mobile information device;

FIG. 5 is a flowchart illustrating the operation of the mobile information device in FIG. 1;

FIG. 6 is a table showing exemplary position identifiers and position data stored in the mobile information device memory 104 in the mobile information device according to the first embodiment;

FIG. 7 is a table showing the data in FIG. 3 as stored in the mobile information device memory 104 in the mobile information device according to the first embodiment, the position identifiers having been converted to position data;

FIG. 8 is a flowchart illustrating the operation of the server in FIG. 1;

FIG. 9 is a diagram illustrating the sequence of operations in the handwriting input system in FIG. 1;

FIG. 10 is a schematic block diagram showing the structure of a handwriting input system according to a second embodiment of the invention;

FIG. 11 is a flowchart illustrating the operation of the electronic pen in FIG. 10;

FIG. 12 is a flowchart illustrating the operation of the mobile information device in FIG. 10;

FIG. 13 is a table showing data sent from the mobile information device to the server when the electronic pen and mobile information device in FIG. 10 are linked one-to-one;

FIG. 14 is a table showing a set of data sent from the mobile information device to the server when a plurality of electronic pens are linked to the mobile information device in FIG. 10;

FIG. 15 is a flowchart illustrating the operation of the server in FIG. 10;

FIG. 16 is a diagram illustrating the sequence of operations in the handwriting input system in FIG. 10;

FIG. 17 is a schematic block diagram showing the structure of a handwriting input system according to a third embodiment of the invention;

FIG. 18 is a flowchart illustrating the operation of the electronic pen in FIG. 17;

FIG. 19 is a flowchart illustrating the operation of the mobile information device in FIG. 17;

FIG. 20 is a table showing a set of data sent from the mobile information device to the server in FIG. 17;

FIG. 21 is a diagram illustrating the sequence of operations in the handwriting input system in FIG. 17;

FIG. 22 is a schematic block diagram showing the structure of a handwriting input system according to a fourth embodiment of the invention;

FIG. 23 is a flowchart illustrating the operation of the electronic pen in FIG. 22;

FIG. 24 is a flowchart illustrating the operation of the mobile information device in FIG. 22;

FIG. 25 is a table showing exemplary pen data numbers, pen time data, position identifiers, trace data, and mobile information device identifiers stored in the memory of the electronic pen in FIG. 22;

FIG. 26 is a table showing exemplary pen data numbers, pen time data, position identifiers, trace data, and mobile information device identifiers stored in the memory of the electronic pen in FIG. 22 when the electronic pen communicates with three mobile information device;

FIGS. 27, 28, and 29 are tables showing examples of the data in FIG. 26 stored in the three mobile information devices, the position identifiers having been converted to position data; and

FIG. 30 is a diagram illustrating the sequence of operations in the handwriting input system in FIG. 22.

### DETAILED DESCRIPTION OF THE INVENTION

Embodiments of the invention will now be described with reference to the attached drawings, in which like elements are indicated by like reference characters.

An electronic pen employing Anoto technology is used as the handwriting input device in these embodiments, and the descriptions will include descriptions of Anoto technology, but the invention is not limited to the use of Anoto handwriting input technology. Other means of handwriting input may be used instead, such as a stylus and tablet built into or connected to a portable computer or PDA.

### First Embodiment

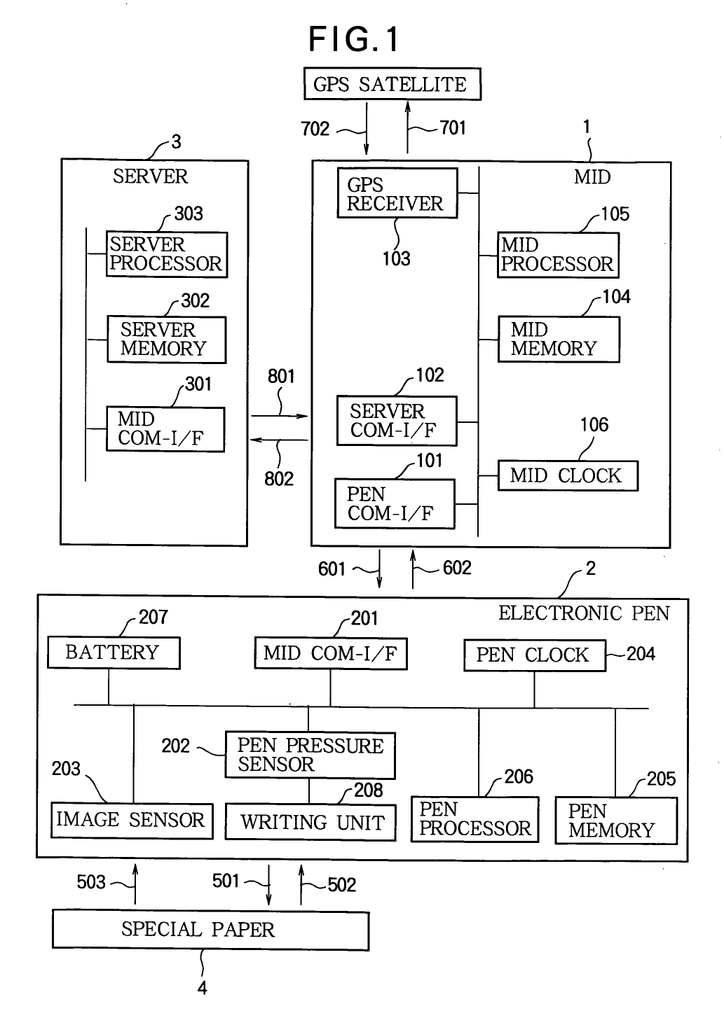

Referring to the block diagram in FIG. 1, the first embodiment is a handwriting input system including a mobile information device or MID 1, an electronic pen 2, a server 3, and a sheet of special paper 4. The electronic pen 2, also referred to below simply as a ‘pen’, and special paper 4 are carried by a person who uses the electronic pen 2 to write on the special paper 4. The mobile information device 1 may be carried by this user or, if the user is riding in a vehicle, may be installed in the same vehicle.

The mobile information device 1 includes an electronic pen communication interface (pen COM-I/F) 101, a server communication interface (server COM-I/F) 102, a global positioning system (GPS) data acquisition unit or GPS receiver 103, a mobile information device memory 104, a mobile information device processor 105, and a mobile information device clock 106.

The electronic pen 2 includes a mobile information device communication interface (MID COM-I/F) 201, a pen pressure sensor 202, an image sensor 203, a pen clock 204, a pen memory 205, a pen processor 206, a battery 207, and a writing unit 208.

The server 3 includes a mobile information device communication interface (MID COM-I/F) 301, a server memory 302, and a server processor 303.

The special paper 4 has a pattern of dots preprinted at horizontal and vertical intervals of substantially 0.3 millimeters (0.3 mm). The dot pattern consists of six-by-six blocks of dots, each occupying a square space 1.8 mm on a side. Each dot is displaced slightly upward, downward, left, or right, giving each six-by-six block one of 436 possible unique patterns. Each six-by-six block on the special paper 4 has a different dot pattern. The dot patterns encode positional coordinates in a finite plane. Some of the dots are also used to specify identification (ID) information that can be used to designate a particular application program that is to process the handwritten input captured by the electronic pen 2. One application program may be designated for the entire special paper 4, or different application programs may be designated for different parts of the special paper 4.

The writing unit 208 is similar to a ball-point pen, having a carbon-based ink cartridge, for example, and writes visible traces 501 on the special paper 4. As the writing unit 208 writes, the pen pressure sensor 202 senses the writing pressure 502, and the image sensor 203, which includes a small complementary metal-oxide-semiconductor (CMOS) image-sensing element, captures images 503 of the traces and the dot pattern at a rate of at least seventy-five images per second. Each image covers a square area 1.8 mm on a side, enabling an image of a full six-by-six block of dots to be captured. The pen processor 206, which controls the image sensor 203, processes the images to identify the encoded positional coordinates of the traces, and combines the coordinates with pen pressure information obtained from the pen pressure sensor 202 and time and date information obtained from the pen clock 204 to generate data sets including at least the pen time (and date) and the trace coordinate data. If necessary, other information describing the pen trajectory may be included, such as the writing speed, writing pressure, and writing angle. Each data set also includes a novel GPS-ID, described below.

In the present embodiment, the writing pressure may simply be processed as an on/off signal indicating whether a trace is or is not being formed. The data sets are stored in the pen memory 205, which has a capacity of at least one megabyte (1 MB), sufficient to store about forty pages of handwritten input if the special paper 4 is of A5 size. At suitable times, the data are sent to the mobile information device 1 through the mobile information device communication interface 201. The communication channel between the mobile information device 1 and the electronic pen 2 is a bidirectional channel 601, 602 such as a universal serial bus (USB) wired link or a Bluetooth wireless link (Bluetooth is a registered trademark). A wireless link is preferable because data are transferred while the pen is being used. The above operations are powered by the battery 207, which holds enough charge for at least two hours, for example, of continuous writing.

When the pen pressure indicates the beginning of a trace, the pen processor 206 sends a request 602 for a position identifier (GPS-ID) to the mobile information device communication interface 201 via the mobile information device communication interface 201, and receives the GPS-ID 601 from the mobile information device 1. At the end of the trace, the pen processor 206 stores a data set including the trace data and the received GPS-ID in the pen memory 205. A GPS-ID is, for example, a two-digit or two-letter code or some other type of short alphanumeric character string that the mobile information device 1 assigns to GPS coordinate data, which the mobile information device 1 obtains by receiving signals from one or more GPS satellites orbiting the earth. When the pen processor 206 sends trace data to the mobile information device 1, it includes the GPS-ID of each trace. Being short, the GPS-IDs can be stored and sent without taking up excessive space in the pen memory 205 or adding significantly to the amount of data that must be transmitted and received by the mobile information device communication interface 201.

The signals from GPS satellites are received by the GPS receiver 103 in the mobile information device 1. Although the GPS satellite communication channel 701, 702 is shown as bidirectional, for ordinary position measurements only the receiving channel 702 is used; the sending channel 701 may be used in differential GPS (DGPS) measurements to communicate with a terrestrial GPS base station (not shown). The signals received from the satellite are processed by the GPS receiver 103 to yield GPS data including the latitude and longitude of the present position of the mobile information device 1. GPS data are generally output in the National Marine Electronics Association (NMEA) 0183 standard format as a sentence of global positioning system fix data (GPGGA), an example of which is

### $GPGGA, 011723, 3801.334, N, 14058.127, E, 1, 8, 1.3, 58.3, M, 37.2, M, 0, 0*7A

In this sentence, ‘$GPGGA’ indicates that the following data represent the result of a position determination by a GPS receiver, ‘011723’ indicates that the position was determined at 01 hours 17 minutes 23 seconds universal time, ‘3801.334, N’ indicates north latitude 38 degrees 1.334 minutes, ‘14058.127, E’ indicates east longitude 140 degrees 58.127 minutes, and the following numbers and letters (1, 8, 1.3, 58.3, M, 37.2, M, 0, 0*7A) indicate that the position was measured by GPS alone, using eight GPS satellites, with a horizontal dilution of position of 1.3 at an elevation of 58.3 meters above sea level and a geode height of 37.2 meters, the age of the differential GPS (DGPS) correction data being zero, the checksum of the DGPS base station being 7A. The mobile information device processor 105 assigns a GPS-ID to this sentence, and stores at least the longitude and latitude coordinate data and the assigned GPS-ID in the mobile information device memory 104.

Although these longitude and latitude coordinates are the coordinates of the mobile information device 1 rather than the electronic pen 2, when the electronic pen 2 receives a GPS-ID from the mobile information device 1, the mobile information device 1 and electronic pen 2 are in close proximity to each other, so for practical purposes they have the same latitude and longitude, and the latitude and longitude data obtained by the GPS receiver 103 in the mobile information device 1 serve equally to identify the position of the electronic pen 2.

When the electronic pen 2 transmits data to the mobile information device 1, the mobile information device processor 105 corrects the pen time data as described later, uses the GPS-ID in each data set to fetch the corresponding GPS longitude and latitude coordinates from the mobile information device memory 104, and then stores the received data with the corrected time and the GPS coordinate data in the mobile information device memory 104, rearranging the data sets in corrected time sequence if necessary.

At appropriate times, the mobile information device processor 105 sends the stored trace data to the server 3 through the server communication interface 102. The server communication interface 102 communicates with the server 3 through a bidirectional communication channel 801, 802 typically including both a wireless link and a wired network link.

In the server 3, the data are received from the mobile information device 1 by the mobile information device communication interface 301, stored in the server memory 302, and managed by the server processor 303. The server processor 303 may process the data itself or make the data available to another processor (not shown) for processing. The processing is carried out by application software. For example, the server processor 303 may execute optical character recognition (OCR) software that converts the trace data to text data, in which case the server processor 303 functions as a data conversion processor, converting the trace data to strings of character codes such as ASCII codes (ASCII stands for American Standard Code for Information Interchange). The handwritten input can then be processed by other application software that accepts ASCII-coded text data.

As another example of data conversion, the handwritten input data may represent a sketch or drawing, which application software running on the server processor 303 converts to bit-mapped image data, or to line and curve image data represented by mathematical formulas.

Data conversion is not limited to the server 3. If the mobile information device 1 has sufficient memory capacity and processing power, it may convert the trace data to ASCII data or image data itself and send the converted data to the server 3 together with the time information and position coordinates indicating where and when the data were entered.

As noted above, the application software that is to process the trace data may be specified by an application identifier encoded in the dot pattern on the special paper 4. In addition, the electronic pen 2 has its own pen identifier (pen-ID). Both identifiers are sent from the electronic pen 2 to the server 3 via the mobile information device 1. The pen-ID enables the server 3 to recognize the trace data as originating from a particular electronic pen 2. If the server 3 lacks the application software specified by the application identifier, it may send the mobile information device 1 the universal resource locator (URL) of another server that is known to have the required application software, and the mobile information device 1 may then transmit the same trace data to the server identified by the URL.

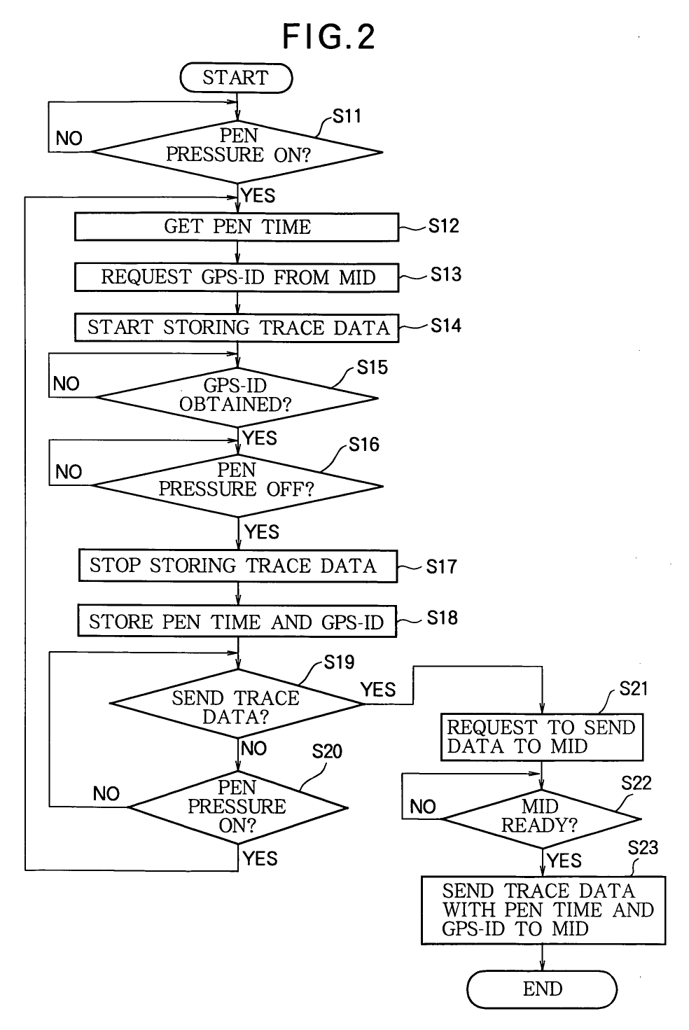

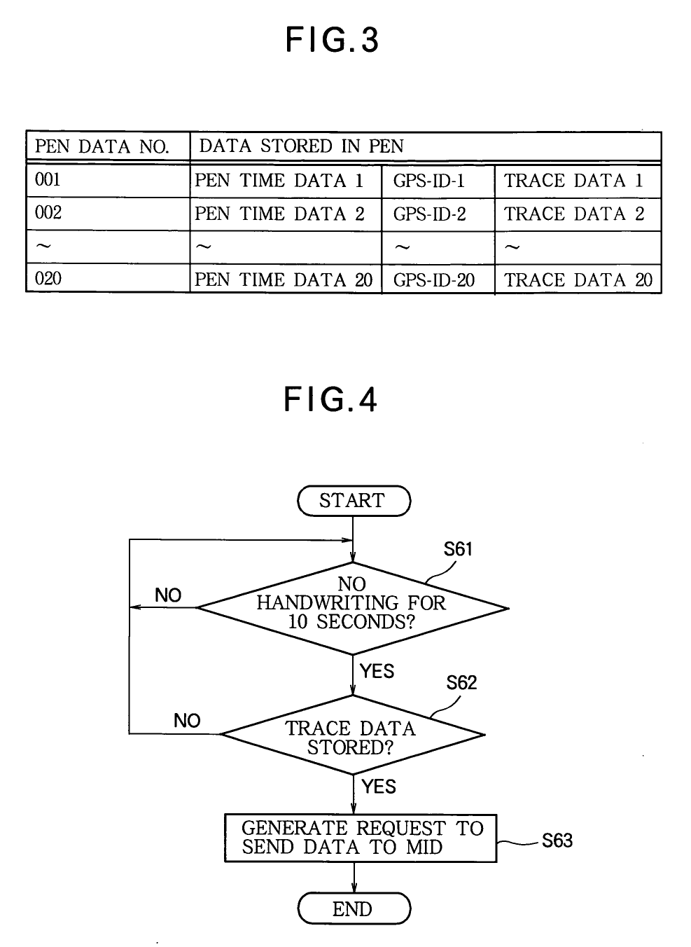

The process by which handwritten input is captured by the electronic pen 2 and transmitted through the mobile information device 1 to the server 3 will now be described with reference to the flowcharts in FIGS. 2, 4, 5, and 8, which illustrate the operation of the processors in the electronic pen 2, mobile information device 1, and server 3. Reference will also be made to the operations indicated by arrows in FIG. 1, and to FIGS. 3, 6, and 7, which illustrate the storage of data in the mobile information device 1 and electronic pen 2.

FIG. 2 schematically illustrates the operation of the pen processor 206. From a starting state in which no trace is being formed and the signal from the pen pressure sensor 202 is accordingly in the off-state, the pen processor 206 waits for the pen pressure signal from the pen pressure sensor 202 to change to the on-state, indicating the beginning of a trace 501 (step S11). When this occurs the pen processor 206 obtains the current pen time from the pen clock 204 (step S12), sends a request for GPS-ID data through the mobile information device communication interface 201 to the mobile information device 1 (step S13), turns on the image sensor 203, processes the images captured by the image sensor 203 to obtain the coordinates of successive points on the trace trajectory, and starts storing the resulting trace coordinate data in the pen memory 205 (step S14).

While processing the image data and storing the trace data, the pen processor 206 also waits for a GPS-ID to arrive from the mobile information device 1 (step S15). When the GPS-ID is received, the pen processor 206 tests the pen pressure signal from the image sensor 203. If the pen pressure signal is in the off-state, indicating that the pen has left the special paper 4 and the trace has ended, the pen processor 206 turns off the pen processor 206 and stops storing trace data (step S17). If the pen-pressure signal is still in the on-state, the pen processor 206 continues storing trace data until the pen-pressure signal goes into the off-state (producing a No decision in step S16), and then turns off the pen processor 206 and stops storing trace data (step 17).

When the GPS-ID has been received and the trace has ended, the pen processor 206 assembles a data set including the pen time, the GPS-ID, and the trace data in the pen memory 205 (step S18), and then tests a condition that determines whether or not to send the data set to the mobile information device 1 (step S19). An exemplary condition is ‘no handwriting input for ten seconds’. If the condition is not satisfied (No in step S19), the pen processor 206 leaves the data set stored in the pen memory 205 and tests the pen pressure signal (step S20). If the pen pressure signal is in the on-state (Yes in step S20), the pen processor 206 returns to step S12 to start storing data for a new trace. If the pen pressure signal is in the off-state (No in step S20), the pen processor 206 returns to step S19 to test the data sending condition, and continues to repeat steps S19 and S20 until either the data sending condition is satisfied or the pen-pressure signal reverts to the on-state.

When the data sending condition is satisfied (Yes in step S19), the pen processor 206 sends a request through the mobile information device communication interface 201 to the mobile information device 1 asking the mobile information device 1 to accept a trace data transmission (step S21), and waits for the mobile information device 1 to reply that it is ready (step S22). When the mobile information device communication interface 201 receives a reply from the mobile information device 1 indicating that the mobile information device 1 is ready, the pen processor 206 sends all unsent data sets stored in the pen memory 205, each including trace data, a pen time, and a GPS-ID, through the mobile information device communication interface 201 to the mobile information device 1 (step S23).

During and after steps S21, S22, and S23, the pen processor 206 continues to monitor the pen-pressure signal (step S11), and if handwriting input resumes, the pen processor 206 again begins executing step S12 and the subsequent steps.

FIG. 3 shows an example of the data stored in the pen memory 205. Each data set is assigned a pen data number. In the example shown, data for twenty traces are stored in twenty data sets, numbered in ascending order from 001 to 020, but in general the pen data numbers are not limited to three-digit numbers and the number of traces that can be stored is limited only by the length of the pen data numbers and the memory capacity of the pen memory 205. In association with each pen data number, the pen processor 206 stores the pen time data indicating the time at which the trace began, the GPS-ID obtained from the mobile information device 1, and the coordinate data of the trace. The first trace (with pen data number 001), which began at a first pen time (given by pen time data 1) and was written while the mobile information device 1 was at a location identified by a first GPS-ID (GPS-ID 1), is described by a first set of coordinate data (trace data 1). Data for succeeding traces are stored in the same way, each data set having its own pen time data and GPS-ID.

FIG. 4 indicates an exemplary procedure by which the pen processor 206 tests the condition for sending the trace data to the mobile information device 1. By comparing the current pen time indicated by the pen clock 204 with the pen time at which the last trace ended, for example, the pen processor 206 determines whether there has been no handwriting input for the last ten seconds (step S61). If this is the case, the pen processor 206 determines whether the pen memory 205 currently stores any trace data sets that have not yet been sent to the mobile information device 1 (step S62). If this is also the case, then the data sending condition is satisfied and the pen processor 206 generates a request to send data to the mobile information device 1 (step S63). The mobile information device communication interface 201 sends this request to the mobile information device 1 in step S21 in FIG. 2.

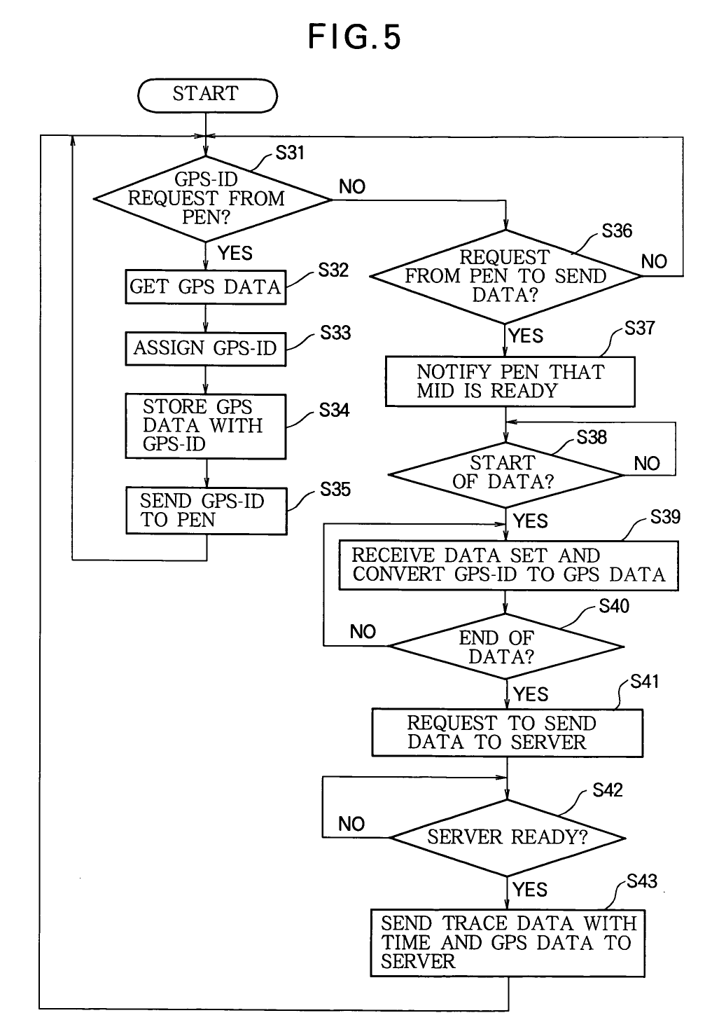

FIG. 5 illustrates the operation of the mobile information device processor 105 in the mobile information device 1. From a starting state in which the mobile information device 1 is not communicating with the electronic pen 2, the mobile information device processor 105 waits to receive from the electronic pen 2 either a GPS-ID request (step S31) or a request to send data from the electronic pen 2 to the mobile information device 1 (step S36).

When a GPS-ID request is received (Yes in step S31), the mobile information device processor 105 uses the GPS receiver 103 to obtain GPS coordinate data (step S32), assigns a GPS-ID to the GPS coordinate data (step S33), stores both the GPS coordinate data and the GPS-ID in the mobile information device memory 104 (step S34), sends the GPS-ID through the electronic pen communication interface 101 to the electronic pen 2 (step S35), and returns to step S31 to wait for anther request from the electronic pen 2.

When a request to send data from the electronic pen 2 is received (Yes in step S36), as soon as it is ready, the mobile information device processor 105 sends a reply through the electronic pen communication interface 101 to the electronic pen 2, indicating its readiness to accept the data (step S37), and waits to begin receiving data sets from the electronic pen 2 (step S38). When data transmission begins, as each trace data set is received, the mobile information device processor 105 uses the GPS-ID included in the data set as a key to fetch the corresponding GPS coordinate data from the mobile information device memory 104, and stores the data set in the mobile information device memory 104, substituting the GPS coordinate data for the GPS-ID and correcting the pen time data (step S39). The mobile information device processor 105 also determines whether each received data set is the last data set in the transmission (step S40), and if it is not, repeats step S39 to receive and store the next data set.

The pen time data can be corrected by various methods. In one exemplary method, when the electronic pen 2 asks the mobile information device 1 to accept a data transmission, the electronic pen 2 sends the present time given by the pen clock 204 to the mobile information device 1; the mobile information device processor 105 in the mobile information device 1 subtracts this present time from the present time given by the mobile information device clock 106, and adds the resulting difference to the pen time in each subsequently received data set. In another exemplary method, when the mobile information device processor 105 stores GPS coordinate data and GPS-IDs in the mobile information device memory 104, it also stores the time at which the GPS coordinate data were obtained, according to the mobile information device clock 106, and when the mobile information device processor 105 receives a data set from the electronic pen 2, it replaces the pen time with the corresponding time recorded in the mobile information device memory 104. If this method is adopted, it is not necessary for the electronic pen 2 to send pen time data to the mobile information device 1. In yet another exemplary method, the mobile information device processor 105 obtains the time data from the GPGGA sentence. If one of the latter methods is adopted, the mobile information device processor 105 replaces the pen times obtained by the electronic pen 2, indicating when each trace began, with times indicating when the corresponding GPS coordinate data were obtained.

The advantage of correcting the pen time data is that the server can receive accurate time data even if the pen clock 204 is inaccurate.

At the end of the transmission (Yes in step S40), the mobile information device 1 sends a request through the server communication interface 102 to the server 3 asking the server 3 to accept a trace data transmission (step S41), and waits for the server 3 to reply that it is ready (step S42). When the server communication interface 102 receives a reply from the server 3 indicating that the server 3 is ready, the mobile information device processor 105 sends the trace data sets stored in the mobile information device memory 104, including the time and the GPS coordinate data, through the server communication interface 102 to the server 3 (step S43).

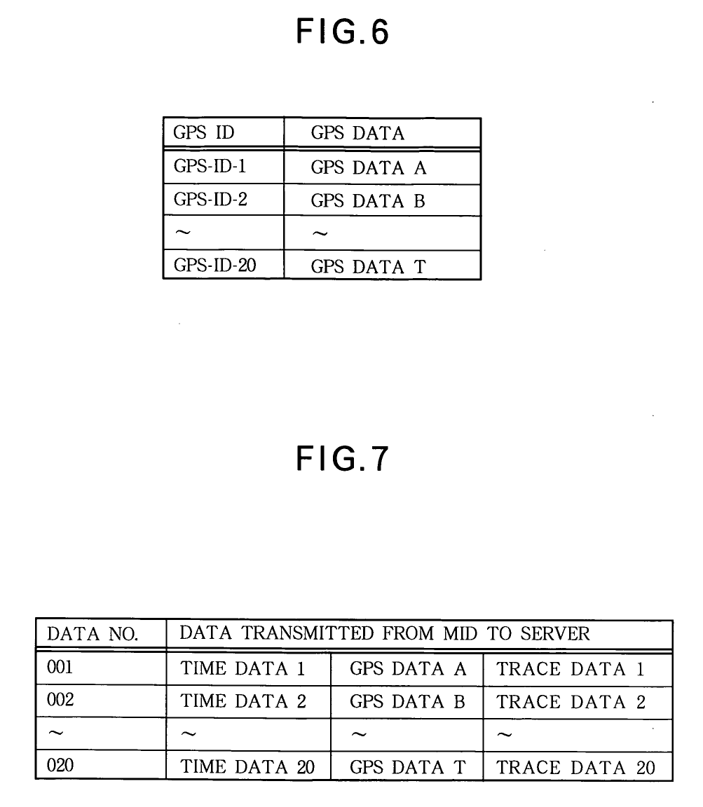

FIG. 6 shows an example of the GPS data stored by the mobile information device processor 105 while the electronic pen 2 is recording handwritten input comprising twenty traces. During the input, each time a new trace begins, the mobile information device 1 receives a GPS-ID request from the electronic pen 2, performs a GPS measurement, assigns a GPS-ID, and stores the measured GPS coordinate data in association with the assigned GPS-ID. GPS-ID-1 is the first assigned GPS-ID and GPS data A are the corresponding GPS coordinate data. GPS-ID-2 is the next assigned GPS-ID and GPS data B are the corresponding GPS coordinate data. GPS-ID-20 is the last assigned GPS-ID and GPS data T are the corresponding GPS coordinate data.

FIG. 7 shows an example of the trace data stored by the mobile information device processor 105 in the mobile information device memory 104. The data numbers (010-020) are the pen data numbers received from the electronic pen 2, and are the same as in FIG. 3. The time data (time data 1 to time data 20) are the pen time data received from the electronic pen 2, as corrected by the mobile information device processor 105. The GPS data (GPS data A to GPS data T) are the GPS coordinate data corresponding to the GPS-IDs received from the electronic pen 2, giving the location of the mobile information device 1 at substantially the times indicated by the time data. The trace data (trace data 1 to trace data 20) are the trace coordinate data received from the electronic pen 2, and are the same as in FIG. 3.

Although not explicitly indicated in FIGS. 5-7, the mobile information device 1 also receives the pen-ID of the electronic pen 2, and sends the pen-ID to the server in step S43 in FIG. 5.

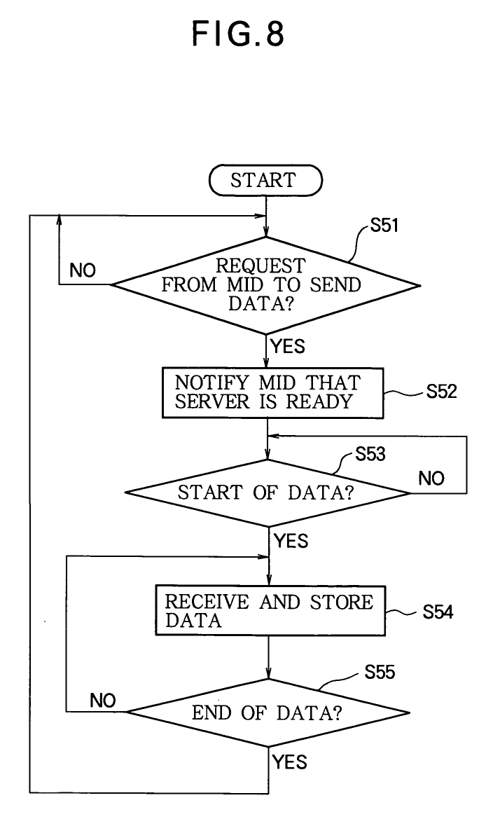

FIG. 8 illustrates the operation of the server processor 303 in the server 3. From a starting state in which the server 3 is not communicating with the mobile information device 1, the server processor 303 waits to receive a request to send trace data from the mobile information device 1 to the server 3 (step S51). When such a request is received (Yes in step S36), as soon as it is ready, the server processor 303 sends a reply through the mobile information device communication interface 201 to the mobile information device 1, indicating its readiness (step S52), and waits to begin receiving the trace data from the mobile information device 1 (step S53). When data transmission begins, as each trace data set is received, the server processor 303 stores the data set, including the GPS coordinate data, in the server memory 302 (step S54). The server processor 303 also determines whether each received data set is the last data set in the transmission (step S55), and if it is not, repeats step S54 to receive and store the next data set. At the end of the transmission (Yes in step S55), the server processor 303 returns to step S51 to wait for the next transmission.

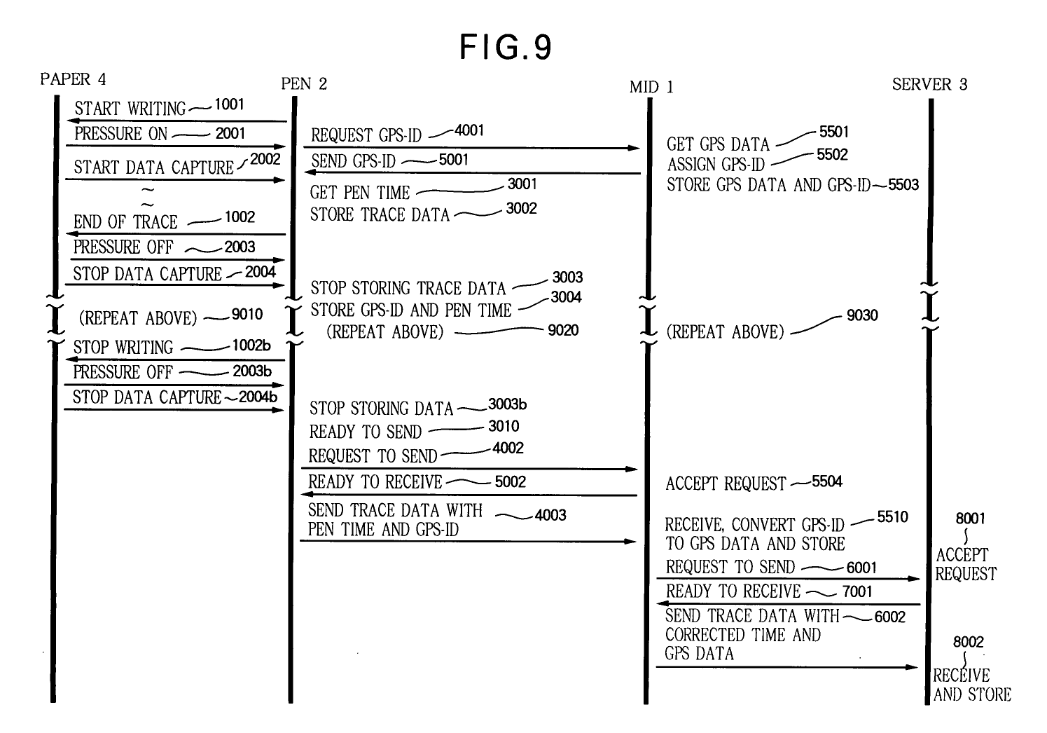

FIG. 9 illustrates the entire handwriting input procedure by showing the flows of information between the special paper 4, electronic pen 2, mobile information device 1, and server 3. When the user starts writing 1001, the pen-pressure signal changes from the off-state to the on-state 2001, causing the electronic pen 2 to send a GPS-ID request 4001 to the mobile information device 1. The mobile information device 1 obtains GPS coordinate data 5501 for its current location, assigns a GPS-ID 5502, stores the GPS coordinate data with the assigned GPS-ID 5503, and sends the GPS-ID 5001 to the electronic pen 2. In the meantime, the electronic pen 2 gets the pen time 3001 from the pen clock 204, turns on the image sensor 203 and starts capturing trace data 2002, and starts storing the trace data 3002.

At the end of the trace 1002 the pen pressure signal changes to the off-state 2003, the image sensor is turned off 2004, the storing of trace data is terminated 3003, and the electronic pen 2 stores the GPS-ID and pen time 3004 in the data set that already includes the corresponding trace data.

As handwriting input continues, generating further traces 9010, the electronic pen 2 repeats the procedure 9020 of requesting and obtaining a GPS-ID and storing the GPS-ID with corresponding time and trace data, and the mobile information device 1 repeats the procedure 9030 of obtaining GPS coordinate data, assigning a GPS-ID, storing the GPS coordinate data and GPS-ID, and sending the GPS-ID to the electronic pen 2.

At the end of the last trace 1002b, the pen pressure signal changes to the off-state 2003b, the image sensor is turned off 2004b, and the storing of trace data is terminated 3003b (which includes storing the GPS-ID and pen time data of the last trace). After, for example, ten seconds without further handwriting input, the electronic pen 2 decides 3010 to transmit the stored data, and sends the mobile information device 1 a request 4002 asking it to accept the data. The mobile information device 1 receives the request 5504 and replies that it is ready 5002. The electronic pen 2 then sends the mobile information device 1 the stored trace data sets, including their pen time data and GPS-IDs 4003.

The mobile information device 1 stores the data it receives from the electronic pen 2, converting the GPS-IDs to GPS coordinate data 5510. At the end of the data transmission from the electronic pen 2, the mobile information device 1 sends the server 3 a request 6001 asking whether it is ready to receive the data. The server 3 accepts the request 8001 and replies that it is ready 7001. The mobile information device 1 then sends the server 3 the stored trace data, including corrected time data and GPS coordinate data 6002. The server 3 receives and stores the data 8002.

Since the data stored by the server 3 include the GPS coordinates of the mobile information device 1 at the time of each handwriting trace captured by the electronic pen 2, the server 3 can automatically determine the location at which each item of handwritten information was entered. This location information can be used in various ways when the handwritten information is processed at the server 3, or at another computing device. Since the location does not have to be entered by hand, the job of data entry is simplified for the user, and the possibility of location entry mistakes is eliminated.

Since the electronic pen 2 stores short GPS-IDs instead of lengthy GPS coordinate data, the GPS information takes up little space in the pen memory 205 and does not significantly reduce the amount of trace data that the electronic pen 2 can hold.

In a variation of the first embodiment, the electronic pen 2 sends trace data to the mobile information device 1 in response to a command entered by hand on the special paper 4, by checking a ‘send’ box, for example. This variation also applies to the following embodiments.

In another variation of the first embodiment, if there is more than one mobile information device 1 within communication range of the electronic pen 2, when requesting a GPS-ID, the electronic pen 2 automatically selects the mobile information device 1 from which it receives the strongest signal, for example, or automatically selects a mobile information device 1 that is not busy, and directs the GPS-ID request and subsequent communication to this mobile information device 1 until it has sent all the trace data stored in its memory 205.

### Second Embodiment

The second embodiment is similar to the first embodiment except that a plurality of users share a single mobile information device 1. Each user uses a different electronic pen 2. To keep the trace data captured by different electronic pens 2 separate in the mobile information device 1 and server 3, each electronic pen 2 places its electronic pen identifier (pen-ID) in each data set that it sends to the mobile information device 1.

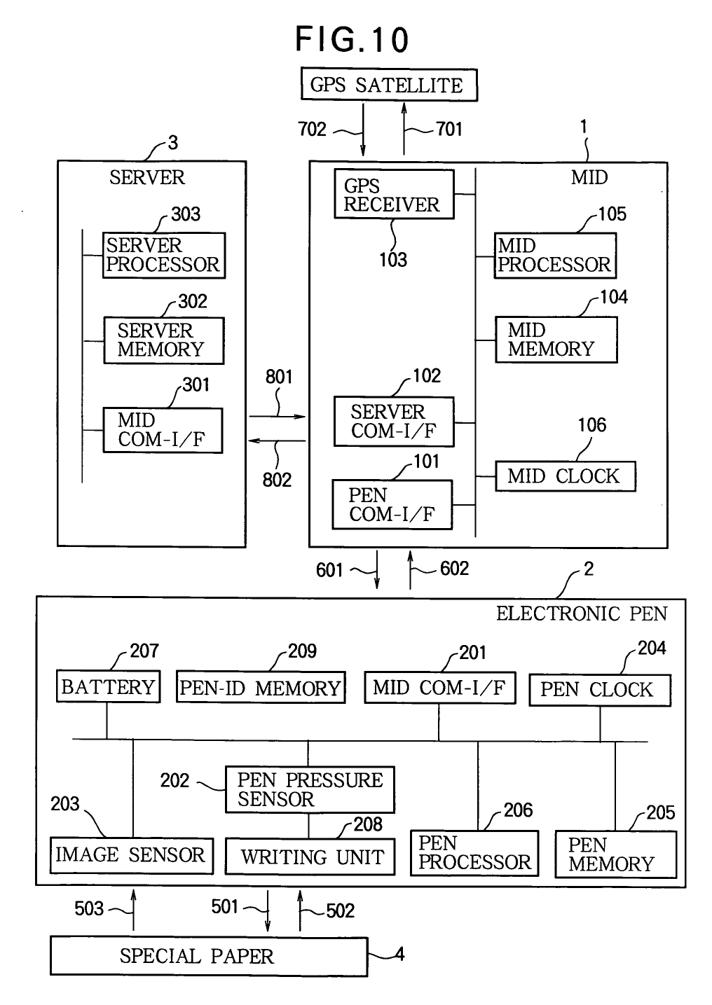

Referring to FIG. 10, the mobile information device 1 and server 3 in the second embodiment have the same internal structure as in the first embodiment. Each electronic pen 2 has the same internal structure as in the first embodiment except that it has an additional pen-ID memory 209 in which its unique pen-ID is stored. For simplicity, only one electronic pen 2 is shown.

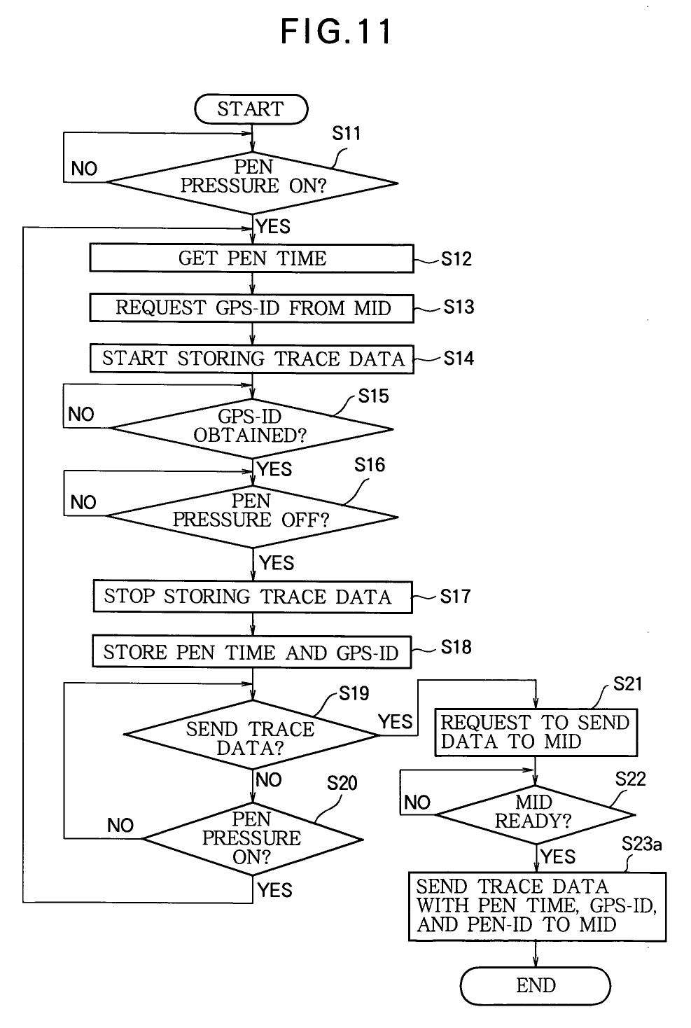

FIG. 11 illustrates the operation of the pen processor 206 in the electronic pen 2 in the second embodiment. Steps S11 to S22 are identical to the corresponding steps in the first embodiment (FIG. 2). In step S23a, when sending trace data to the mobile information device 1, in addition to the trace coordinate data, pen time data, and GPS-ID data, the electronic pen 2 also sends its pen-ID in each data set.

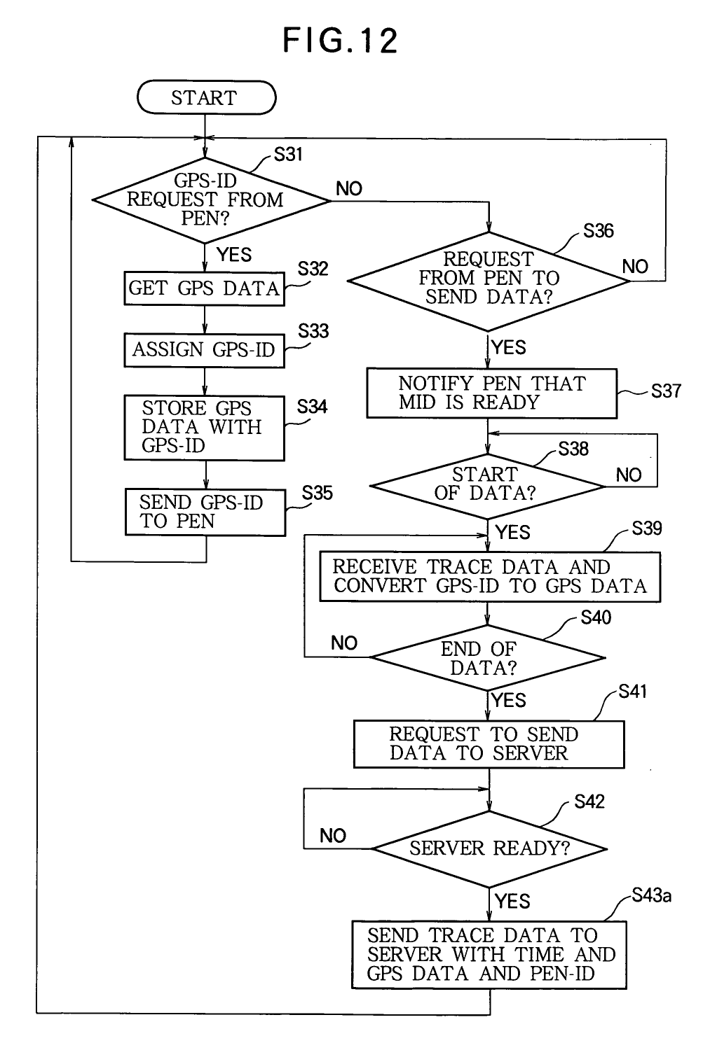

FIG. 12 illustrates the operation of the mobile information device processor 105 in the mobile information device 1 in the second embodiment. Steps S31 to S42 are identical to the corresponding steps in the first embodiment (FIG. 5), except that in step S39, each data set received from an electronic pen 2 includes the pen-ID. In step S43a, when sending trace data to the server 3, in addition to sending the trace data, corrected time data, and GPS coordinate data, the mobile information device 1 also sends the pen-IDs of the electronic pens 2 from which the data were received.

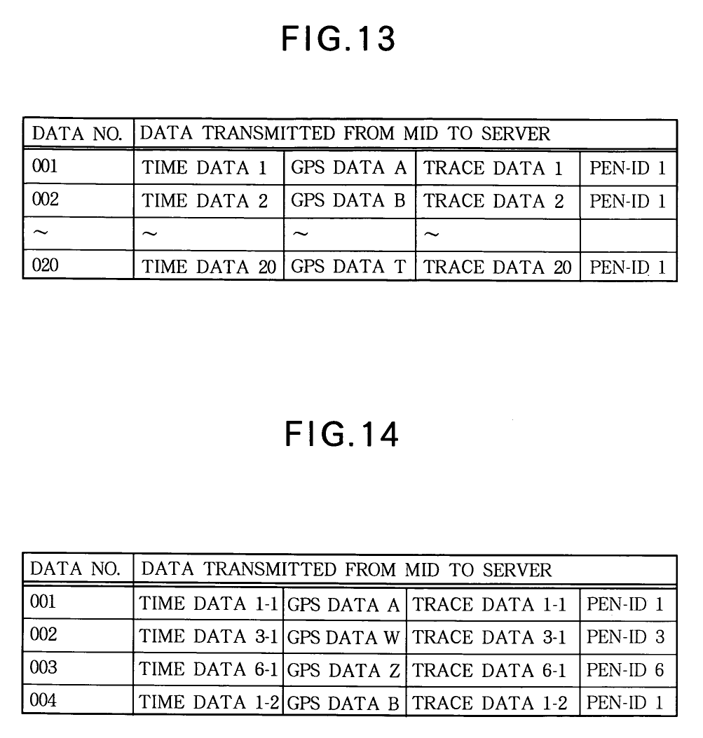

FIG. 13 shows exemplary data sent from the mobile information device 1 to the server 3 when the mobile information device 1 communicates with only one electronic pen 2. The data are the same as in the first embodiment (FIG. 7) except for the inclusion of the pen-ID (pen-ID 1) of the electronic pen 2 in each data set.

FIG. 14 shows exemplary data sent from the mobile information device 1 to the server 3 when the mobile information device 1 communicates with a plurality of electronic pens 2. The data numbers are serial numbers assigned by the mobile information device 1 in the order in which the data were received from the electronic pens 2 and do not correspond to the serial numbers assigned by any particular electronic pen 2. The first data set (No. 001) includes trace data 1-1 received from a first electronic pen 2 having a first pen-ID (pen-ID 1). The second data set (No. 002) includes trace data 1-2 received from an electronic pen 2 having another pen-ID (pen-ID 3). The third data set (No. 003) includes trace data 6-1 received from an electronic pen 2 having yet another pen-ID (pen-ID 6). The fourth data set (No. 004) includes further trace data 1-2 received from the first electronic pen 2. Each data set includes the time data obtained by correcting the pen time data received from the corresponding electronic pen 2 and the GPS coordinate data of the mobile information device 1 at that time.

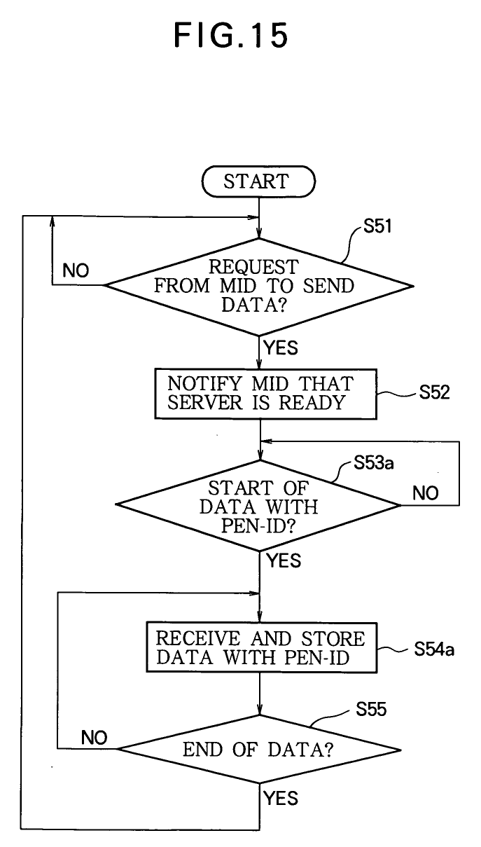

FIG. 15 illustrates the operation of the server processor 303 in the server 3 in the second embodiment. Steps S51, S52, and S55 are the same as in the first embodiment (FIG. 8). Steps S53a and S54a are similar to the corresponding steps (S53 and S55) in the first embodiment, except that each data set that the server 3 receives and stores now includes a pen-ID indicating the electronic pen from which each data set originated, as shown in FIGS. 13 and 14.

The server 3 stores the trace data, including the pen time data, GPS coordinate data, and pen-ID data, in the order in which the data are received from the mobile information device 1. In processing the data, the server 3 may sort the data sets according to their pen-IDs, so that the traces constituting a single user's handwritten input can be processed in a single series by application software.

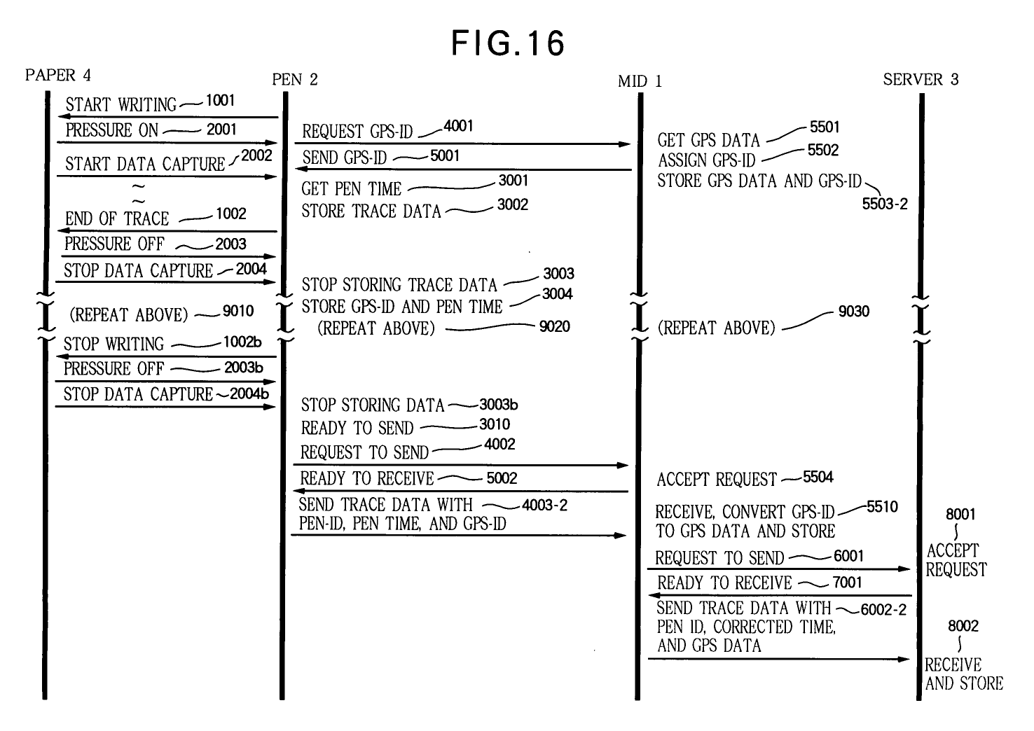

FIG. 16 illustrates the entire handwriting input procedure in the second embodiment, showing the flow of data between the server 3, the mobile information device 1, and a single electronic pen 2 that writes on a single special paper 4. The steps involving the electronic pen 2 are the same as in the first embodiment, except that when the electronic pen 2 sends each data set to the mobile information device 1, it sends its pen-ID as well as the pen time, GPS-ID, and trace data 4003-2. The steps involving the mobile information device 1 are the same as in the first embodiment except that when the mobile information device 1 stores GPS coordinate data and GPS-ID data 5503-2, it also stores the pen-ID of the electronic pen 2 that requested and receives the GPS-ID, and when the mobile information device 1 sends each data set to the server 3, it sends the pen-ID as well as time data, GPS coordinate data, and trace data 4003-2. The steps involving the server 3 are the same as in the first embodiment except that when the server 3 stores the data received from the mobile information device 1, it stores a pen-ID as well as time data, GPS coordinate data, and trace data 8002-2 in each data set.

The second embodiment provides the same effects as the first embodiment, with the additional effect that a plurality of users can share a single mobile information device 1. The pen-IDs prevent the data entered by different users and captured by different electronic pens 2 from becoming confused.

In a variation of the second embodiment, instead of placing its pen-ID in each data set, the electronic pen 2 sends its pen-ID once at the beginning of each data transmission, and the mobile information device 1 places the received pen-ID in each data set.

In another variation of the second embodiment, in place of pen-IDs, the mobile information device 1 uses the addresses of the electronic pens 2 to which it sends requested GPS-IDs. The mobile information device 1 sends these addresses to the server 3 together with the trace data, time data, and GPS coordinate data, and the server 3 identifies the different electronic pens 2 by their addresses.

In yet another variation of the second embodiment, if there is more than one mobile information device 1 within communication range of an electronic pen 2, when requesting a GPS-ID, the electronic pen 2 automatically selects the mobile information device 1 from which it receives the strongest signal, for example, or automatically selects a mobile information device 1 that is not busy.

### Third Embodiment

The third embodiment is similar to the first embodiment except that there are a plurality of mobile information devices. Each mobile information device has its own device identifier, also referred to below an MID-ID.

While the electronic pen 2 is capturing handwritten input, the user may move or signal reception conditions may change. In this situation, if the electronic pen were to switch from communicating with a first mobile information device to communicating with a second mobile information device, and were to send the second mobile information device GPS-IDs received from the first mobile information device, the second mobile information device would be unable to convert the GPS-IDs to GPS coordinate data. The third embodiment is accordingly adapted so that the electronic pen does not switch arbitrarily from one mobile information device to another.

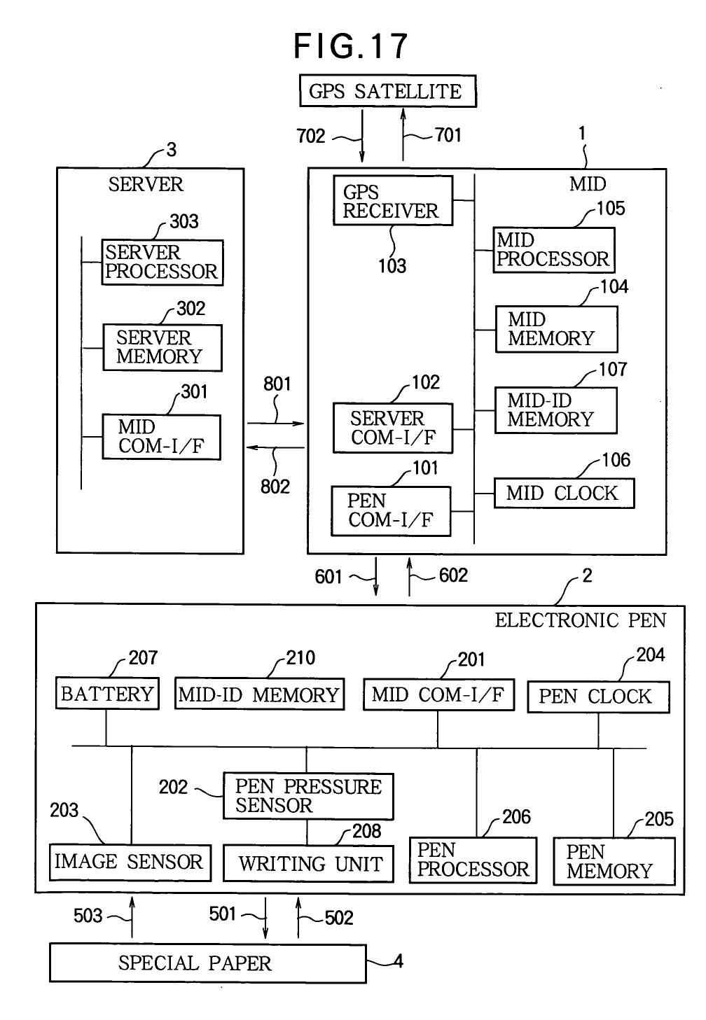

Referring to FIG. 17, the server 3 in the third embodiment has the same internal structure as in the first embodiment. Each mobile information device 1 has the same internal structure as in the first embodiment except that it has an additional MID-ID memory 107 in which its unique device ID (MID-ID) is prestored (only one mobile information device 1 is shown). The electronic pen 2 has the same internal structure as in the first embodiment except that it has an additional MID-ID memory 210 in which the MID-ID of the mobile information device 1 with which the electronic pen 2 communicates is preset.

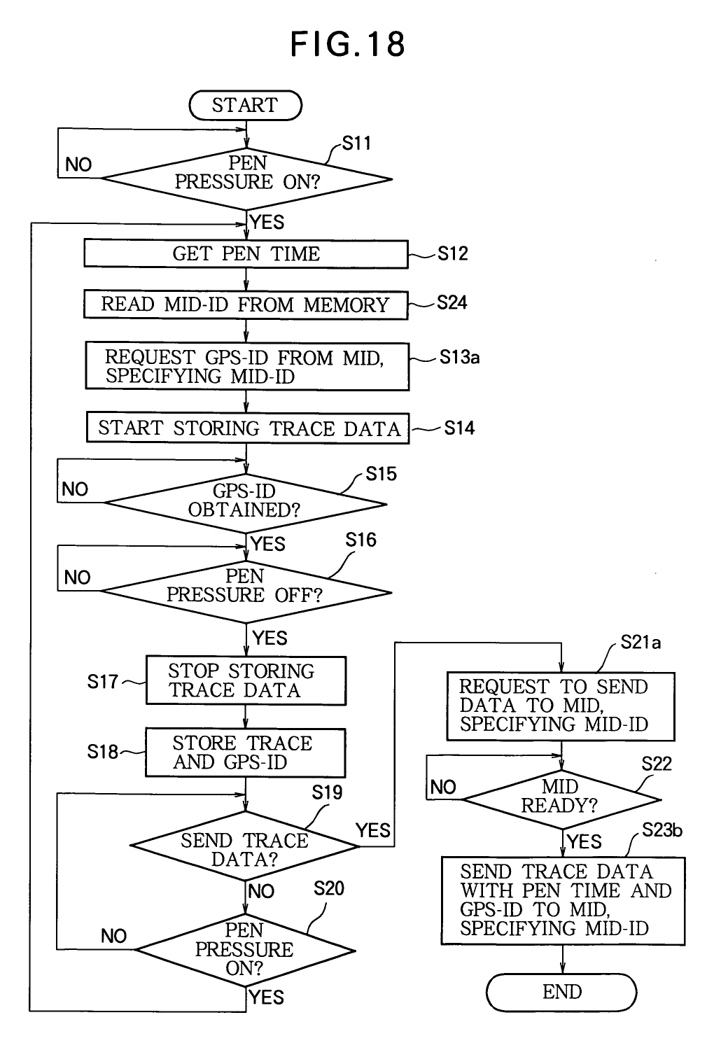

FIG. 18 illustrates the operation of the pen processor 206 in the electronic pen 2 in the third embodiment. Steps S11 and S12 are identical to the corresponding steps in the first embodiment (FIG. 2). Next, the pen processor 206 reads the MID-ID stored in its MID-ID memory 210 (step S24), and transmits a request for a GPS-ID, specifying this MID-ID (step S13a). Steps S14 to S20 are the same as in the first embodiment. Following a Yes decision to send data in step S19, the pen processor 206 transmits another request, specifying the MID-ID read from the MID-ID memory 210 and asking if the mobile information device 1 with this MID-ID is ready to accept a data transmission (step S21a). When the mobile information device communication interface 201 receives a reply from this mobile information device 1 indicating that it is ready (producing a Yes decision in step S22), the pen processor 206 sends the trace data stored in the pen memory 205 through the mobile information device communication interface 201 to the mobile information device 1, including the pen time and the GPS-ID data as in the first embodiment and also specifying the MID-ID read from the MID-ID memory 210 as the destination of the transmission (step S23a).

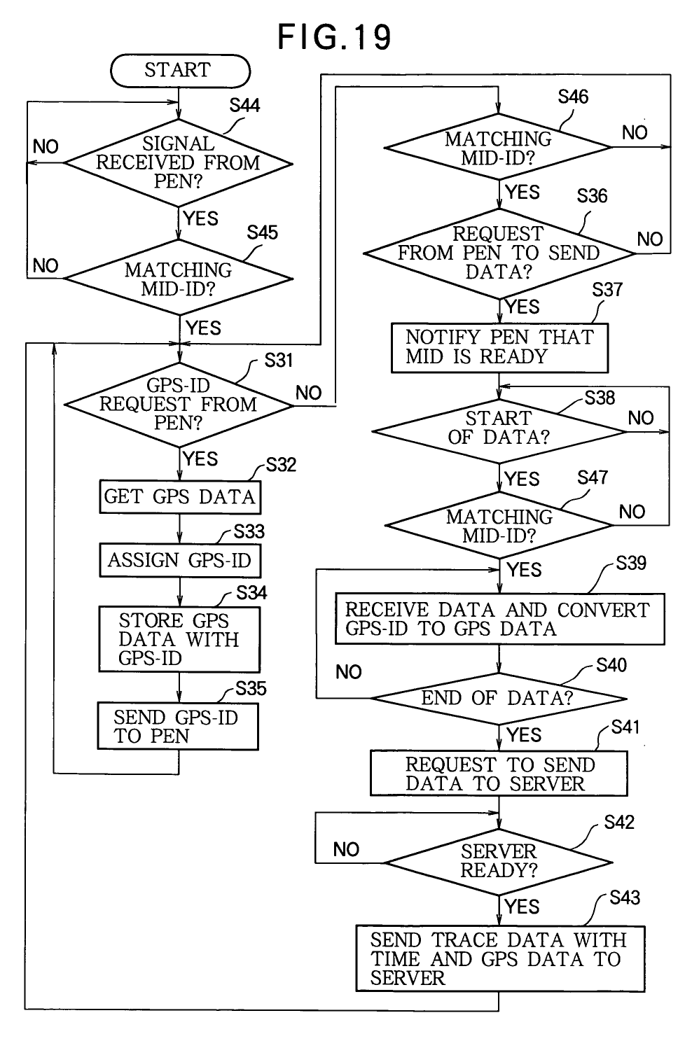

FIG. 19 illustrates the operation of the mobile information device processor 105 in a mobile information device 1 in the third embodiment. This operation is the same as in the first embodiment (FIG. 5), except that before taking action on any signal received from an electronic pen, the mobile information device processor 105 checks that the signal is accompanied by an MID-ID matching the MID-ID stored in the MID-ID memory 107 of the mobile information device 1, and ignores the signal if this is not the case.

Accordingly, the mobile information device 1 initially waits to receive a signal from the electronic pen 2 (step S44). When a signal is received, the mobile information device processor 105 reads the MID-ID of the mobile information device 1 from the MID-ID memory 107 and compares it with the MID-ID specified in the received signal. If the MID-IDs fail to match, the mobile information device processor 105 returns to step S44 to wait for the next signal. If MID-IDs match, the mobile information device processor 105 proceeds to step S31.

Steps S31 to S33 and S35 are identical to the corresponding steps in the first embodiment. When a Yes decision is produced in step S31 (the electronic pen 2 is requesting a GPS-ID), after assigning a GPS-ID in step S33 to the GPS coordinate data obtained in step S32, the mobile information device processor 105 stores the GPS coordinate data and the assigned GPS-ID in the mobile information device memory 104 in association with its own MID-ID (step S34b).

When a No decision is produced in step S31 (the electronic pen 2 is not requesting a GPS-ID), the mobile information device processor 105 again reads the MID-ID of the mobile information device 1 from the MID-ID memory 107 and compares it with the signal received from the electronic pen 2 (step S46). If the received signal specifies a matching MID-ID, the mobile information device processor 105 determines if the electronic pen 2 is asking to send data to the mobile information device 1 (step S36). If so, the mobile information device processor 105 notifies the electronic pen 2 that it is ready (step S37), waits to start receiving data from the electronic pen 2 (step S38), and checks that the MID-ID accompanying the received data matches the MID-ID stored in the MID-ID memory 107 at the mobile information device 1 (step S47). If the IDs match, the mobile information device processor 105 proceeds with steps S39 to S43 as in the first embodiment, receiving the trace data from the electronic pen 2 and sending the trace data to the server 3.

If the electronic pen 2 is not asking to send data in step S36, the mobile information device processor 105 returns to step S31 and determines whether the electronic pen 2 is requesting another GPS-ID. The mobile information device processor 105 also returns to step S31 when it does not receive a matching MID-ID in step S46.

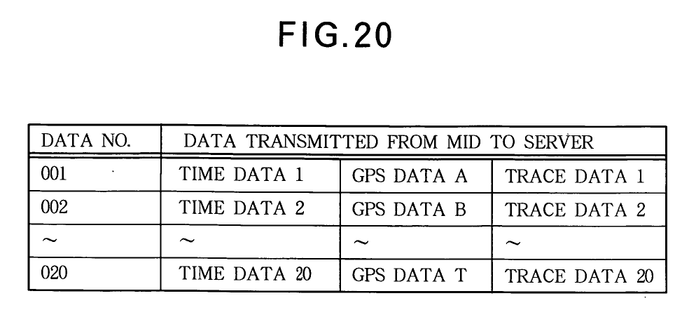

FIG. 20 shows exemplary data sent from the mobile information device 1 to the server 3 in step S43. The data are the same as in the first embodiment (FIG. 7).

The operation of the server processor 303 in the third embodiment is identical to the operation in the first embodiment, so a description will be omitted.

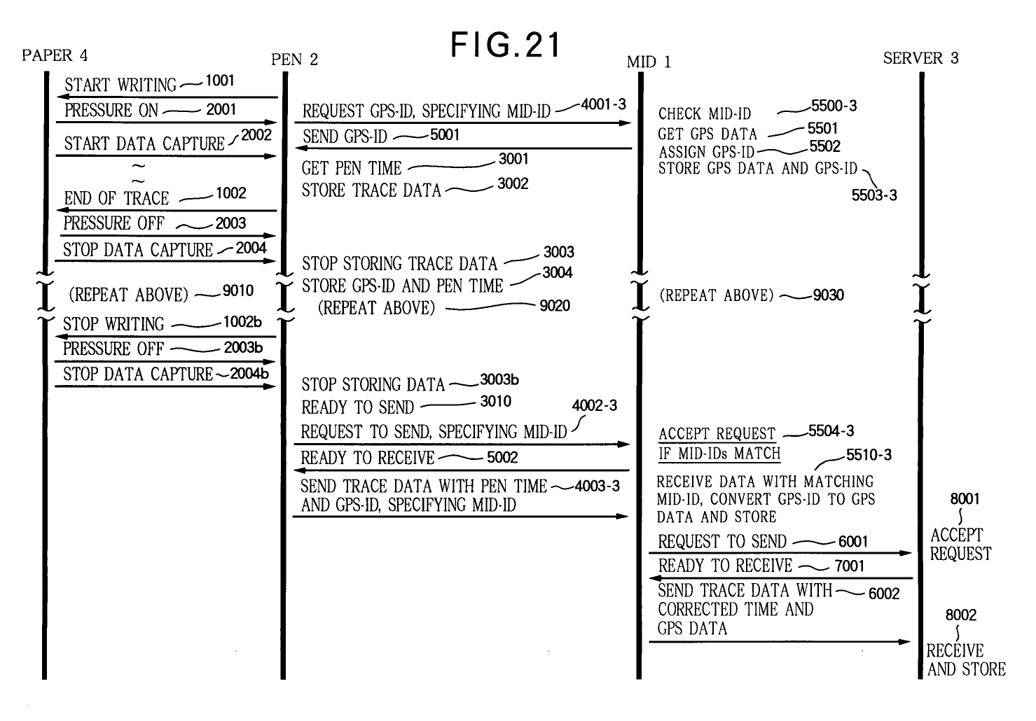

FIG. 21 illustrates the entire handwriting input procedure in the third embodiment, showing the flow of data between a single mobile information device 1 and the electronic pen 2 and server 3.

The steps involving the electronic pen 2 are the same as in the first embodiment, except that when the electronic pen 2 requests a GPS-ID 4001-3 from the mobile information device 1, asks the mobile information device 1 to accept a data transmission 4002-3, and sends trace data 4003-3 to the mobile information device 1, the electronic pen 2 specifies the mobile information device's MID-ID.

The steps involving the mobile information device 1 are the same as in the first embodiment except that upon receiving a request for a GPS-ID from the electronic pen 2, the mobile information device 1 checks that its own MID-ID matches the MID-ID specified in the request 5000-3, and proceeds to obtain GPS coordinate data 5501 and assign a GPS-ID 5502 only if the two MID-IDs match; when the mobile information device 1 stores the GPS coordinate data and a GPS-ID, these data are associated with the MID-ID 5503-3; when the electronic pen 2 asks the mobile information device 1 to accept a trace data transmission, the mobile information device 1 checks that its own MID-ID matches the MID-ID specified in the request 5504-3 and accepts the request by replying that it is ready only if the two MID-IDs match; and when receiving trace data from the electronic pen 2, the mobile information device 1 again checks that its own MID-ID matches the MID-ID specified in the data transmission, and converts the GPS-IDs in the trace data to GPS coordinate data and stores the trace data only if the two MID-IDs match 5510-3.

The steps involving the server 3 are the same as in the first embodiment.

The third embodiment provides the same effects as the first embodiment, with the additional effect that the electronic pen 2 can be used in an environment in which a plurality of mobile information devices 1 are present. Since the electronic pen 2 communicates only with the mobile information device 1 having the MID-ID preset in the electronic pen's MID-ID memory 210, the electronic pen 2 and this mobile information device 1 operate as in the first embodiment.

In a variation of the third embodiment, the MID-ID stored in the MID-ID memory 210 is updated at the start of the procedure in FIG. 18. For example, the mobile information device communication interface 201 and pen processor 206 may monitor signals transmitted by different mobile information devices 1, select the strongest signal, and write the source address specified in this signal in the MID-ID memory 210. This variation enables the electronic pen 2 to search for and communicate with the closest one of a plurality of mobile information devices 1, since the closest mobile information device will normally produce the strongest signal. The electronic pen 2 cannot change its communication destination from a first mobile information device to a second mobile information device, however, until it has transmitted all the trace data currently stored in its pen memory 205 to the first mobile information device.

In another variation of the third embodiment, the system includes a plurality of electronic pens 2. As in the second embodiment, each electronic pen 2 has a pen-ID memory, and each trace data set transmitted from an electronic pen 2 to a mobile information device 1, or from a mobile information device 1 to the server 3, includes the pen-ID of the electronic pen 2 that captured the trace data.

### Fourth Embodiment

The fourth embodiment is similar to the third embodiment in that there are a plurality of mobile information devices, but differs from the third embodiment in that the electronic pen can switch from one mobile information device to another mobile information device between successive traces, and even if a data transmission from the electronic pen is handed off from one mobile information device to another during the transmission, the GPS-IDs can be converted to the correct GPS coordinates.

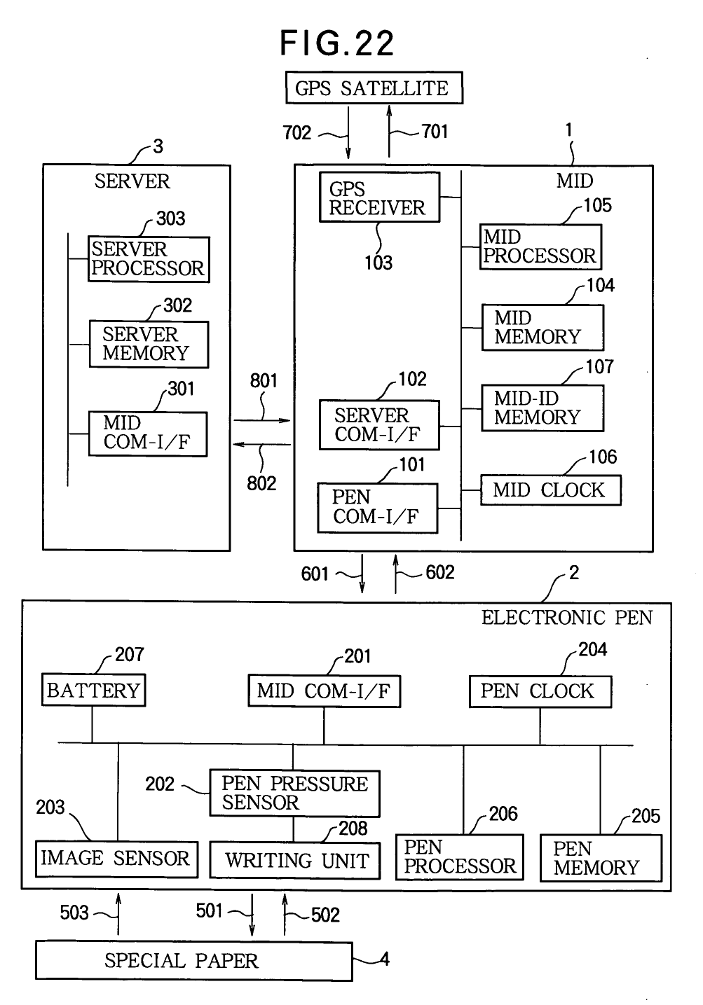

Referring to FIG. 22, the mobile information devices 1 in the fourth embodiment are similar to the mobile information devices 1 in the third embodiment, each including an MID-ID memory 107 in which a unique mobile information device identifier (MID-ID) is stored. The electronic pen 2 and server 3 in the fourth embodiment have the same internal configuration as in the first embodiment.

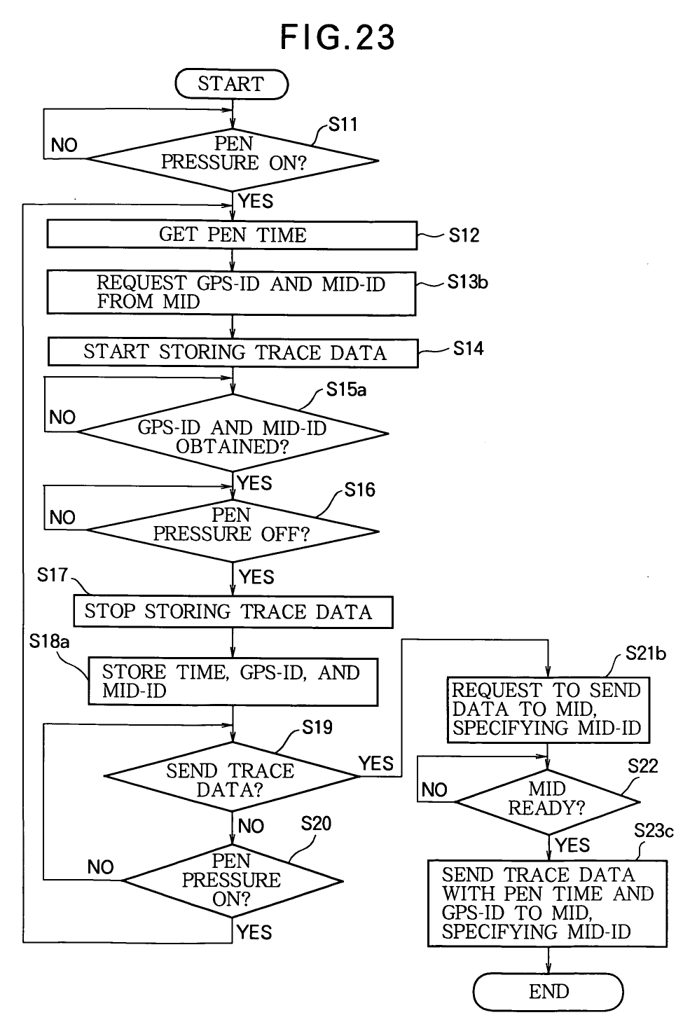

FIG. 23 conceptually illustrates the operation of the pen processor 206 in the electronic pen 2 in the fourth embodiment. Steps S11, S12, S14, S16, S17, S19, S20, and S22 are the same as in the first embodiment. The other steps differ from the first embodiment as follows.

In step S13b, when the pen processor 206 requests a GPS-ID from a mobile information device 1, it also requests the MID-ID of the mobile information device 1.

In step S15a, the pen processor 206 waits to receive both the GPS-ID and the MID-ID from the mobile information device 1.

In step S18a, after storing coordinate data for one trace, the pen processor 206 completes the data set by storing the pen time obtained in step S12 and the GPS-ID and MID-ID obtained in steps S13b and S15a.

In step S21b, when sending a request asking a mobile information device 1 to receive a data transmission from the electronic pen 2, the pen processor 206 specifies the MID-ID obtained in steps S13b and S15a.

In step S23c, when sending each data set the pen processor 206 sends not only the pen time, GPS-ID, and trace data but also the MID-ID of the mobile information device 1 that is to receive the data set.

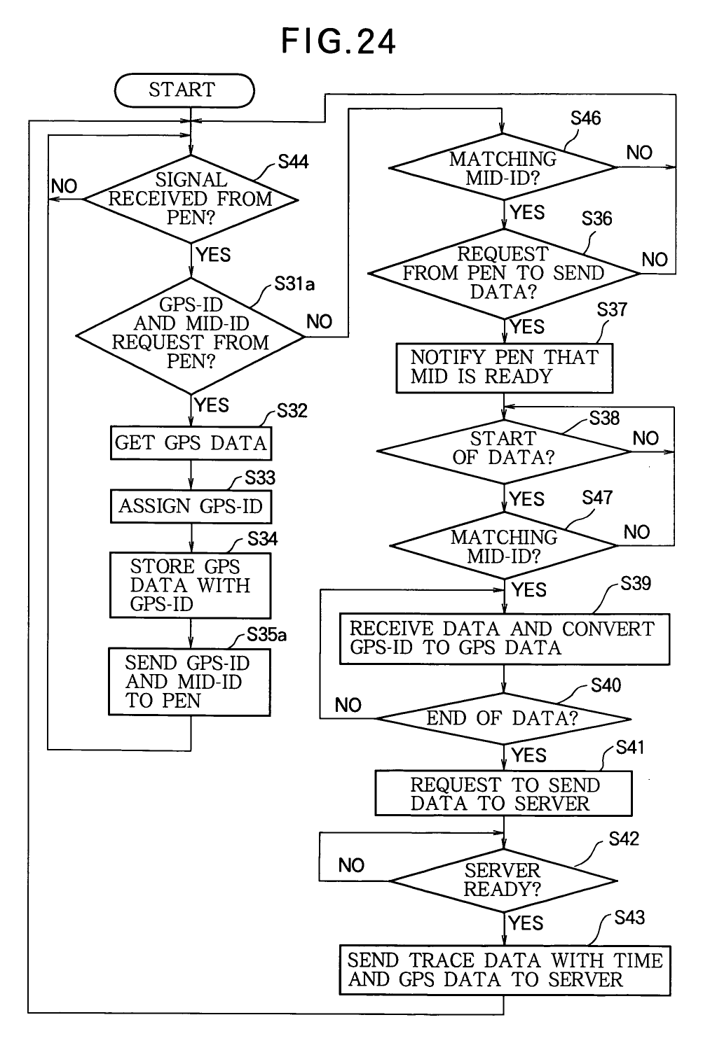

FIG. 24 conceptually illustrates the operation of the mobile information device processor 105 in the mobile information device 1 in the fourth embodiment. The mobile information device processor 105 waits to receive a signal from the electronic pen 2 (step S44). When a signal is received, the mobile information device processor 105 determines whether the signal is a request for a GPS-ID and MID-ID (step S31a). If the signal is a request for a GPS-ID and MID-ID, the mobile information device processor 105 proceeds to obtain GPS coordinate data from the GPS receiver 103 (step S32), assign a GPS-ID (step S34), and store the GPS coordinates and GPS-ID (step S35) as in the preceding embodiments. The mobile information device processor 105 then reads the MID-ID stored in the MID-ID memory 107, sends the GPS-ID and MID-ID to the electronic pen 2 (step S35a), and returns to step S44.

If the signal received from the electronic pen 2 is not a request for a GPS-ID and MID-ID, producing a No decision in step S31a, the mobile information device processor 105 decides whether the received signal specifies an MID-ID matching the MID-ID stored in the MID-ID memory 107 (step S46), and if so, whether the signal is a request to send data from the electronic pen 2 to the mobile information device 1 (step S36). If both of these conditions are satisfied, the mobile information device processor 105 notifies the electronic pen 2 that is ready to begin receiving data (step S37) and waits for the data transmission from the electronic pen 2 to start (step S38). As each data set in the transmission arrives, the mobile information device processor 105 checks whether the data set includes an MID-ID matching the MID-ID stored in the MID-ID memory 107 (step S47). If the MID-IDs match, the mobile information device processor 105 proceeds as in the third embodiment to receive the data, convert the included GPS IDs to GPS coordinate data, and send the data to the server 3 (steps S39-S43), then returns to step S44.

If the MID-IDs do not match in step S47, the mobile information device processor 105 forwards the data set to the mobile information device 1 having the MID-ID specified in the data set, and returns to step S38 to wait for the next data set. Data sets may be forwarded between mobile information devices 1 over, for example, the same communication network by which the mobile information devices 1 communicate with the server 3. When a mobile information device 1 receives a data set forwarded from another mobile information device, it processes the data set in the same way as a data set received directly from the electronic pen 2.

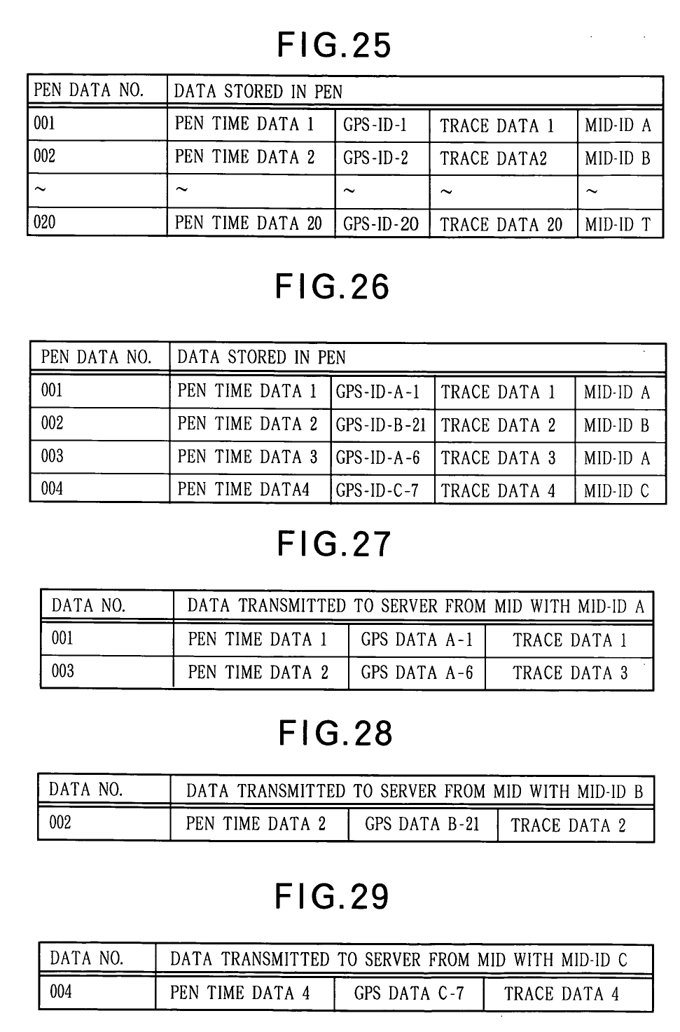

FIG. 25 illustrates the general format in which trace data are stored in the electronic pen 2 in the fourth embodiment. As in the preceding embodiments, data sets are numbered by consecutive pen data numbers (001, 002, . . . ). Each data set includes pen time data indicating the time at which the trace began, the GPS-ID obtained from a mobile information device 1 during the trace, the trace coordinate data, and the MID-ID of the mobile information device 1 from which the GPS-ID was obtained. Each data set may have a different MID-ID, or some or all of the MID-IDs may be the same.

FIG. 26 shows a specific example in which the first and third data sets include GPS-IDs received from a mobile information device 1 with MID-ID A, the second data set includes a GPS-ID received from another mobile information device 1 with MID-ID B, and the fourth data set includes a GPS-ID received from yet another mobile information device 1 with MID-ID C.

The data in FIG. 26 accordingly reach the server 3 from three different mobile information devices 1. From the mobile information device 1 with MID-ID A, the server 3 receives the data shown in FIG. 27, including the GPS coordinate data (GPS data A-1 and A-6) to which this mobile information device 1 converted the GPS-IDs (GPS-ID-A-1 and GPS-ID-A-6 in FIG. 26) submitted by the electronic pen 2. From the mobile information device 1 with MID-ID B, the server 3 receives the data shown in FIG. 28, including the GPS coordinate data (GPS data B-21) to which this mobile information device 1 converted the GPS-ID (GPS-ID-B-21 in FIG. 26) submitted by the electronic pen 2. From the mobile information device 1 with MID-ID C, the server 3 receives the data shown in FIG. 29, including the GPS coordinate data (GPS data C-7) to which this mobile information device 1 converted the GPS-ID (GPS-ID-C-7 in FIG. 26) submitted by the electronic pen 2.

The server 3 operates in substantially the same way in the fourth embodiment as in the first and third embodiments. After receiving trace data captured by a single electronic pen 2 via multiple mobile information devices 1, the server 3 may sort the data sets according to, for example, the time data included therein, so that application software can process the traces in the order in which they were written.

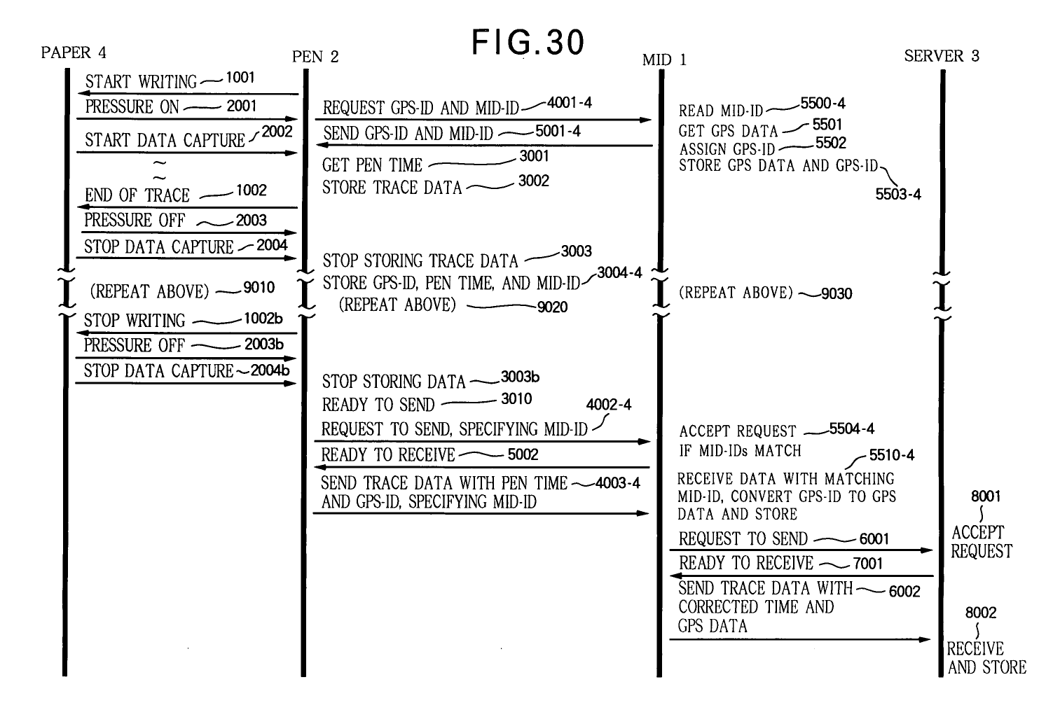

FIG. 30 conceptually illustrates the entire handwriting input procedure in the fourth embodiment, showing the flow of data between a single mobile information device 1 and the electronic pen 2 and server 3.

The steps involving the electronic pen 2 are the same as in the first embodiment, except that when the electronic pen 2 requests a GPS-ID 4001-4, it also requests the MID-ID of the mobile information device 1 that supplies the GPS-ID; when the electronic pen 2 stores a data set 3004-4, it stores the received MID-ID as well as the GPS-ID and pen time together with the trace data; and when the electronic pen 2 asks a mobile information device 1 to accept a data transmission 4002-4 and sends trace data 4003-4 to the mobile information device 1, the electronic pen 2 specifies the MID-ID of the mobile information device 1 that supplied the GPS-ID in each data set.

The steps involving the mobile information device 1 are the same as in the first embodiment except that when so requested by the electronic pen 2, the mobile information device 1 sends both a GPS-ID and its own MID-ID 5001-4; when the mobile information device 1 stores GPS coordinate data and a GPS-ID, these data are associated with the MID-ID 5003-4; when the electronic pen 2 asks the mobile information device 1 to accept a trace data transmission 4002-4, the mobile information device 1 checks that its own MID-ID matches the MID-ID specified in the request and replies that it is ready only if the two MID-IDs match 5504-4; and when receiving trace data sets from the electronic pen 2, the mobile information device 1 again checks that its own MID-ID matches the MID-ID specified in each data set, and converts the GPS-ID in the data set to GPS coordinate data and stores the data set only if the two MID-IDs match 5510-4.

The steps involving the server 3 are the same as in the first embodiment.

The fourth embodiment provides the same effects as the first embodiment, with the additional effect that the electronic pen 2 can make use of a plurality of mobile information devices 1 to obtain GPS-IDs and send trace data to the server 3, even during the same handwriting input session. In particular, a user can use the electronic pen 2 and special paper 4 to enter handwritten data while moving from place to place, without being compelled to carry a mobile information device 1 along, provided there is always a mobile information device 1 within communication range to supply the requested GPS-IDs. When the electronic pen 2 transmits data sets to a mobile information device, even while the transmission is in progress, the transmission can be handed off to another mobile information device, provided the hand-off is made after one complete data set has been transmitted and before the next data set is transmitted.

In a variation of the fourth embodiment, the system includes a plurality of electronic pens 2. As in the second embodiment, each electronic pen 2 has a pen-ID memory, and each trace data set transmitted from an electronic pen 2 to a mobile information device 1, or from a mobile information device 1 to the server 3, includes the pen-ID of the electronic pen 2 that captured the trace data. The server 3 can sort the data sets first according to the included pen-IDs, and then according to the time data, so that application software can process the trace data captured by each electronic pen 2 separately, in the sequence in which the traces were written by the user of the electronic pen 2, regardless of the routes by which the data reached the server 3.

In another variation of the fourth embodiment, instead of requesting a GPS-ID and MID-ID from any mobile information device 1 within range, the electronic pen 2 selects a particular mobile information device 1, such as the non-busy mobile information device 1 from which it receives the strongest signal, and addresses its request to that specific mobile information device 1.

The procedures illustrated in FIGS. 23 and 24 can be modified in various ways provided that each data set stored in the electronic pen 2 eventually reaches the server 3 via the mobile information device 1 identified in the data set, and that this mobile information device 1 converts the GPS-ID in the data set to GPS coordinate data. During this process, the data set may be forwarded through an arbitrary number of mobile information devices 1, both before and after the conversion of the GPS-ID to GPS coordinate data.

The procedures illustrated in the flowcharts in the first three embodiments may also be modified in various ways.

Those skilled in the art will recognize that further variations are possible within the scope of the invention, which is defined in the appended claims.

What is claimed is:

1. A handwriting input system including a handwriting input device for capturing trace data describing handwriting traces, a mobile information device for receiving the trace data from the handwriting input device, and a server for receiving the trace data from the mobile information device, storing the trace data, and using the stored trace data in a prescribed application, wherein:
the mobile information device comprises
a first memory,
a first communication interface for receiving a position identifier request from the handwriting input device, sending a position identifier to the handwriting input device, and receiving a first data set including the trace data and the position identifier from the handwriting input device,
a position determining unit for obtaining position data indicating a present position of the mobile information device when the first communication interface receives the position identifier request,
a first processor for generating the position identifier, storing the position identifier and the position data in mutual association in the first memory, storing the first data set in the first memory, fetching the position data from the first memory by using the position identifier in the first data set as a key, and replacing the position identifier in the first data set with the fetched position data, thereby generating a second data set, and
a server communication interface for sending the second data set to the server;
the handwriting input device comprises
a second communication interface for sending the position identifier request and the first data set to the mobile information device and receiving the position identifier from the mobile information device,
a second memory,
a second processor for generating the position identifier request, storing the trace data captured by the handwriting input device in the second memory as one part of the first data set, and storing the position identifier received by the second communication interface in the second memory as another part of the first data set; and
the server comprises
a third communication interface for receiving the second data set from the mobile information device; and
a third memory for storing the second data set.

2. The handwriting input system of claim 1, wherein the position determining unit comprises a global positioning system receiver.

3. The handwriting input system of claim 1, wherein the handwriting input device further comprises a sensor for detecting initiation and termination of a handwriting trace, and the first data set includes the trace data captured from the initiation to the termination of the handwriting trace.

4. The handwriting input system of claim 3, wherein the handwriting input device captures trace data for a series of handwriting traces, and the second processor generates a position identifier request at the initiation of each handwriting trace in the series of handwriting traces and stores a corresponding series of first data sets in the second memory, each first data set including the position identifier received by the second communication interface in response to the position identifier request generated at the initiation of the corresponding handwriting trace.

5. The handwriting input system of claim 4, wherein the second processor tests a predetermined condition, and if the predetermined condition is satisfied, sends a data transmission request through the second communication interface to the mobile information device, asking the mobile information device to accept a data transmission, receives a reply indicating that the mobile information device is ready to receive the transmission, and then sends the series of first data sets stored in the second memory through the second communication interface to the mobile information device.

6. The handwriting input system of claim 5, wherein the first processor, after converting the first data sets to second data sets by replacing the position identifiers in the first data sets with the corresponding position data, sends a data transmission request through the server communication interface to the server, asking the server to accept a data transmission, receives a reply indicating that the server is ready to receive the data transmission, and then sends the second data sets through the server communication interface to the server.

7. The handwriting input system of claim 1, wherein:
the mobile information device further comprises a first clock for indicating the present time;
the handwriting input device further comprises a second clock for indicating the present time;
the second processor stores the present time indicated by the second clock as a pen time in the first data set; and
the first processor corrects the pen time in the first data set according to a difference between the present time indicated by the first clock and the present time indicated by the second clock and stores the corrected pen time in the second data set.

8. The handwriting input system of claim 1, wherein:
the mobile information device further comprises a first identifier memory storing a device identifier of the mobile information device;
the handwriting input device further comprises a second identifier memory storing the device identifier of the mobile information device;
the second processor places the device identifier of the mobile information device in the position identifier request;
the first processor checks the device identifier received in the position identifier request and generates the position identifier only if the device identifier received in the position identifier request matches the device identifier stored in the first identifier memory;
when sending the first data set to the mobile information device, the second processor specifies the device identifier as a destination identifier; and
the first processor checks the destination identifier and stores the first data set in the first memory only if the destination identifier matches the device identifier stored in the first identifier memory.

9. The handwriting input system of claim 1, wherein:
the mobile information device further comprises a first identifier memory storing a device identifier of the mobile information device;
the first communication interface sends the device identifier together with the position identifier to the handwriting input device;
the second processor stores the device identifier in the first data set;
when sending the first data set to the mobile information device, the second processor specifies the device identifier as a destination identifier; and
the first processor checks the destination identifier and stores the first data set in the first memory only if the destination identifier matches the device identifier stored in the first identifier memory.

10. The handwriting input system of claim 1, wherein the first communication interface and the second communication interface are wireless communication interfaces.

11. The handwriting input system of claim 1, wherein the handwriting input device further comprises a second identifier memory storing an input device identifier identifying the handwriting input device, and the second processor also stores the input device identifier in the second memory as still another part of the first data set.

12. A handwriting input system including a plurality of handwriting input devices for capturing trace data describing handwriting traces, a mobile information device for receiving the trace data from the handwriting input devices, and a server for receiving the trace data from the mobile information device, storing the trace data, and using the stored trace data in a prescribed application, wherein each handwriting input device has an input device identifier, and wherein:
the mobile information device comprises
a first communication interface for receiving data sets from the handwriting input devices, each received data set including the trace data for a single trace captured by the handwriting input device from which the data set is received and the input device identifier of the handwriting input device from which the data set is received,
a first memory for storing said each received data set, and
a server communication interface for sending said each received data set to the server;
said each handwriting input device comprises
a first identifier memory storing the input device identifier of the handwriting input device,
a second memory for storing the trace data captured by the handwriting input device, and
a second communication interface for sending the data sets, including the trace data and the input device identifier, to the mobile information device; and
the server comprises
a third communication interface for receiving the data sets from the mobile information device; and
a third memory for storing the data sets.

13. The handwriting input system of claim 12, wherein:
the mobile information device further comprises a first processor, and
a first clock for indicating the present time;
each handwriting input device further comprises a second processor, and
a second clock for indicating the present time;
the second processor stores the present time indicated by the second clock as a pen time in the data sets, and
the first processor corrects the pen time in said each received data set stored according to a difference between the present time indicated by the first clock and the present time indicated by the second clock in the handwriting input device from which the data set was received.

14. The handwriting input system of claim 12, wherein the first communication interface and the second communication interface are wireless communication interfaces.

15. The handwriting input system of claim 12, wherein:
the mobile information device further comprises
a processor, and
a second identifier memory storing a device identifier of the mobile information device;
said each handwriting input device further comprises a third identifier memory storing the device identifier of the mobile information device;
when sending the data set to the mobile information device, the second communication interface specifies the device identifier of the mobile information device as a destination identifier; and
the processor checks the destination identifier and stores the data set in the first memory only if the destination identifier matches the device identifier stored in the second identifier memory.

16. The handwriting input system of claim 12, wherein:
the mobile information device further comprises
a processor, and
a second identifier memory storing a device identifier of the mobile information device;
when any one of the handwriting input devices captures said trace data the second communication interface in said any one of the handwriting input devices sends the mobile information device a request for the device identifier of the mobile information device and the first communication interface sends the device identifier of the mobile information device to said any one of the handwriting input devices;
when sending the data set to the mobile information device the second communication interface specifies the device identifier of the mobile information device as a destination identifier; and
the processor checks the destination identifier and stores the data set in the first memory only if the destination identifier matches the device identifier stored in the second identifier memory.

17. The handwriting input system of claim 12, wherein the handwriting input system includes a plurality of mobile information devices identical to said mobile information device.
